(19) United States
(12) Patent Application Publication
(10) Pub. No.: US 2026/0081661 A1
(43) Pub. Date: Mar. 19, 2026

(54) NUMBER OF SPATIAL DOMAIN BASES REPORTING FOR MULTIPLE TRANSMISSION RECEPTION POINTS

(71) Applicant: QUALCOMM Incorporated, San Diego, CA (US)

(72) Inventors: Jing DAI, Beijing (CN); Chao WEI, Beijing (CN); Wei XI, Beijing (CN); Liangming WU, Beijing (CN); Min HUANG, Beijing (CN)

(21) Appl. No.: 19/108,925

(22) PCT Filed: Nov. 4, 2022
(86) PCT No.: PCT/CN2022/129986

§ 371 Date: Mar. 5, 2025

(51) Int. Cl. H04B 7/06; H04W 72/044; H04W 72/0453

(52) U.S. Cl. CPC H04B 7/0626; H04W 72/0453; H04W 72/046

(57) ABSTRACT

Certain aspects of the present disclosure provide a method of wireless communications by a user equipment (UE). The method includes receiving configuration information indicating resources for a set of transmission reception points (TRPs); selecting a codepoint from a set of codepoints based at least in part on a quantity of TRPs in the set of TRPs and a total quantity of SD bases for the set of TRPs, the codepoint indicating a quantity of spatial domain (SD) bases selected by the UE for each TRP of the set of TRPs; and transmitting channel state information (CSI) signaling that includes an indication of the codepoint that indicates the quantity of SD bases for each TRP.

### BACKGROUND

### Field of the Disclosure

Aspects of the present disclosure relate to wireless communications, and more particularly, to techniques for reporting a number of spatial domain bases for multiple transmission reception points.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes receiving configuration information indicating resources for a set of transmission reception points (TRPs); selecting a codepoint from a set of codepoints based at least in part on a quantity of TRPs in the set of TRPs and a total quantity of SD bases for the set of TRPs, the codepoint indicating a quantity of spatial domain (SD) bases selected by the UE for each TRP of the set of TRPs; and transmitting channel state information (CSI) signaling that includes an indication of the codepoint that indicates the quantity of SD bases for each TRP.

Another aspect provides a method for wireless communications at a network entity. The method includes transmitting, to a UE configuration information indicating resources for a set of TRPs; receiving, from the UE, CSI signaling that includes a codepoint associated with a quantity of SD bases for each TRP in the set of TRPs; and determining the quantity of SD bases for each TRP in the set of TRPs based at least in part on a quantity of TRPs in the set of TRPs, a total quantity of SD bases for the set of TRPs, and the codepoint.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a conceptual example of precoder matrices.

FIG. 6 is a block diagram depicting an example of codebook based channel state feedback (CSF).

FIG. 7 depicts example transmitter receiver point (TRP) scenarios.

FIGS. 8-9 depicts conceptual examples of precoder matrices.

FIG. 10 depicts various coherent joint transmission (CJT) and non-coherent joint transmission (NCJT) scenarios.

FIG. 11 depicts an example block diagram of uplink control information (UCI) signaling.

FIG. 12 depicts a block diagram of UCI signaling.

FIG. 13 depicts a block diagram of CSI signaling.

FIG. 14 depicts a block diagram of CSI signaling.

FIG. 15 depicts a block diagram of CSI signaling.

FIG. 16 depicts a method for wireless communications.

FIG. 17 depicts a method for wireless communications.

FIG. 18 depicts aspects of an example communications device.

FIG. 19 depicts aspects of an example communications device.

### DETAILED DESCRIPTION

Aspects of the present disclosure provide apparatuses, methods, processing systems, and computer-readable mediums for reporting a number of spatial domain bases for multiple transmission reception points (TRPs).

A user equipment (UE) may acquire channel state information (CSI) during the process of channel estimation. Various enhancements of CSI acquisition in certain scenarios are being considered, such as coherent joint transmission (CJT) targeting certain frequency ranges (e.g., FR1) and multiple TRPs (e.g., up to 4 TRPs). Certain assumptions may be made in such cases, such as an ideal backhaul and synchronization as well as the same number of antenna ports across TRPs.

The motivation for enhanced CSI for CJT scenarios may include to enable a larger number of ports for lower-frequency bands (e.g., FR1), with distributed TRPs (which may also be referred to as panels). For a single-TRP or panel with, for example, 32 ports, the antenna array size would be too large for practical deployment. With the introduction of CJT mTRP, and with an increased number or quantity of TRPs (e.g., increased from 2 to 4 TRPs), there may be the need to limit signaling and processing overhead, which may otherwise increase with the increase in the number of TRPs.

According to some techniques, a number of SD bases parameter (Lₙ) may be supported, for example in the context of Type-II codebook refinement for CJT mTRP. A UE may be configured with one or more sets of CSI-RS resources, and the parameter Lₙ may be applicable per CSI-RS. According to some techniques, a value of Lₙ may be configured by a network entity, such as a gNB, for each TRP of a set of TRPs that are to be used to communicate with a UE. However, network configuration may result in less throughput than configuration of the values of Lₙ by a UE. For example, a network entity may transmit to the UE an indication of the total number of SD bases across all the TRPs (L or Lₜₒₜ), and the UE may determine the values of Lₙ for each TRP based on the value of L. However, while the UE is aware of what are the values of Lₙ for the TRPs, the base station also should know Lₙ so that the base station can appropriately communicate with the UE via the TRPs.

A UE may receive configuration from a network entity (e.g., gNB) indicating resources for the UE for a set of TRPs (e.g., mTRPs). The UE may then select a codepoint from a set of codepoints based at least in part on a quantity of TRPs (e.g., N) in the set of TRPs and a total quantity of SD bases (e.g., Lₜₒₜ) for the set of TRPs. This codepoint may indicate to the network entity a quantity of SD bases (e.g., Lₙ) selected by the UE for each TRP of the set of TRPs. For example, a UE may select one or more, or all of the values of Lₙ for the TRPs. The UE may then transmit CSI signaling that includes an indication of the codepoint that indicates the quantity of SD bases for each TRP.

The CSI signaling may include two or more parts, including a first CSI part and a second CSI part. In some examples, the codepoint may be communicated in the first CSI part. In some examples, the codepoint may be communicated in the second CSI part. The UE may determine an accumulated quantity of SD bases corresponding to the set of TRPs, and determine the codepoint based on the accumulated quantity of SD bases.

The described techniques may result in higher or increased throughput in communications between the UE and the network entity via the TRPs. For example the UE may be better able to select the SD bases in part because the UE may better understand the operating conditions of the UE than a network entity that would otherwise select values of the SD bases. CSI reporting overhead may also be reduced by using a codepoint that requires fewer bits than other techniques, and may result in more efficient use of a wireless medium, and reduced processing time and power for a UE.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

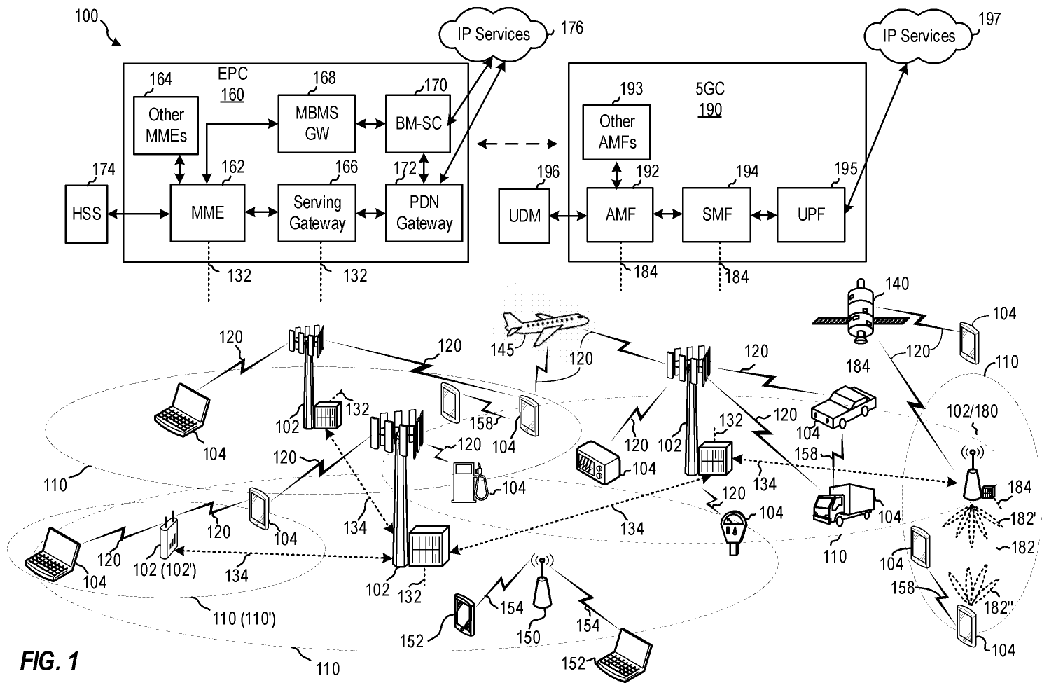

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

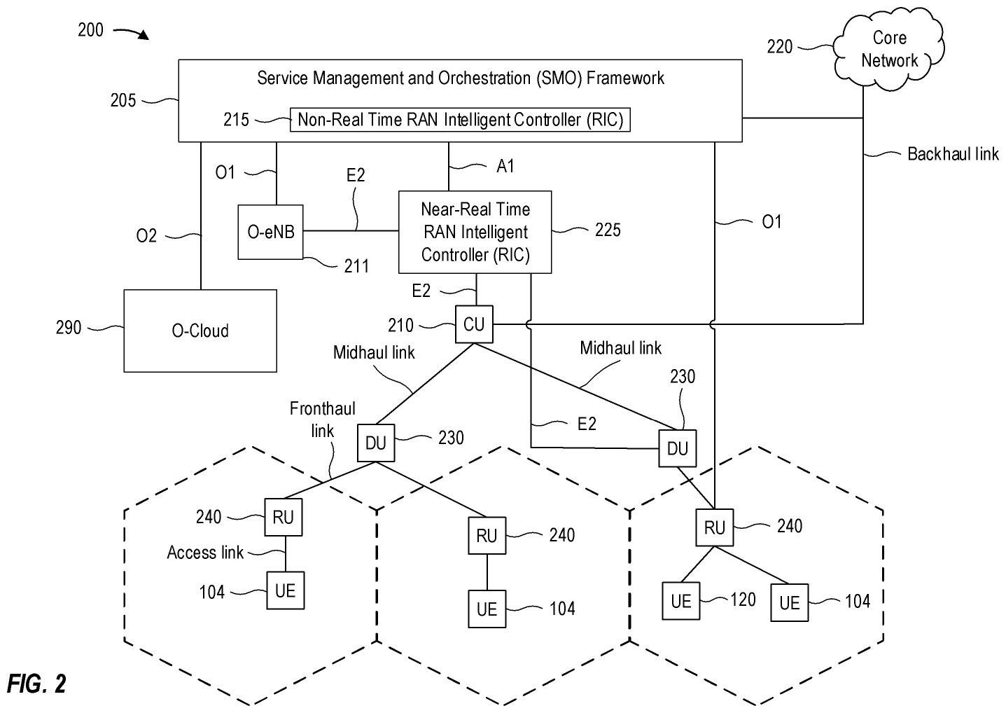

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

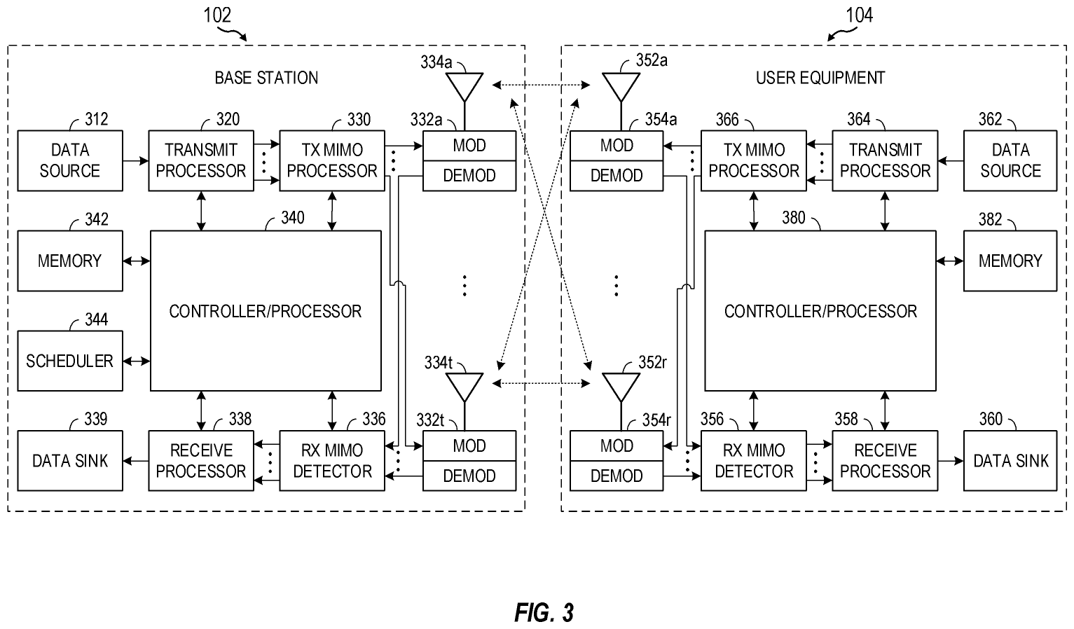

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

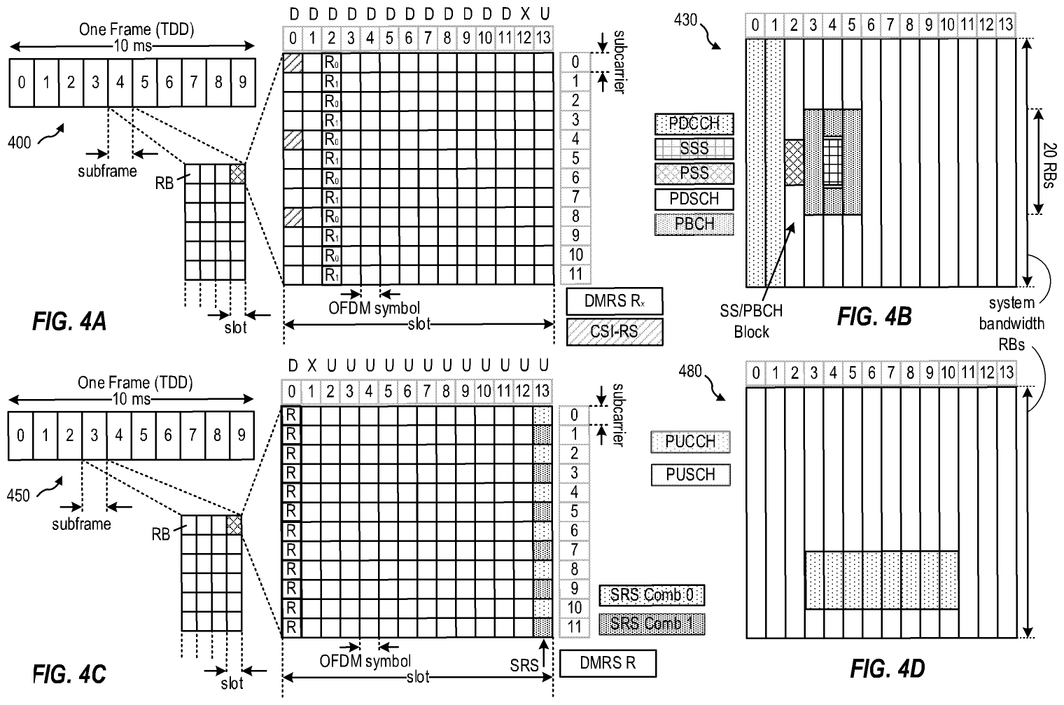

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example CSI Report Configuration

Channel state information (CSI) may refer to channel properties of a communication link. The CSI may represent the combined effects of, for example, scattering, fading, and power decay with distance between a transmitter and a receiver. Channel estimation using pilots, such as CSI reference signals (CSI-RS), may be performed to determine these effects on the channel. CSI may be used to adapt transmissions based on the current channel conditions, which is useful for achieving reliable communication, in particular, with high data rates in multi-antenna systems. CSI is typically measured at the receiver, quantized, and fed back to the transmitter.

The time and frequency resources that can be used by a user equipment (UE) to report CSI are controlled by a base station (BS) (e.g., gNB). CSI may include channel quality indicator (CQI), precoding matrix indicator (PMI), CSI-RS resource indicator (CRI), SS/PBCH Block Resource indicator (SSBRI), layer indicator (LI), rank indicator (RI) and/or L1-RSRP. However, as described below, additional or other information may be included in the report.

A UE may be configured by a BS for CSI reporting. The BS may configure UEs for the CSI reporting. For example, the BS configures the UE with a CSI report configuration or with multiple CSI report configurations. The CSI report configuration may be provided to the UE via higher layer signaling, such as radio resource control (RRC) signaling (e.g., CSI-ReportConfig). The CSI report configuration may be associated with CSI-RS resources for channel measurement (CM), interference measurement (IM), or both. The CSI report configuration configures CSI-RS resources for measurement (e.g., CSI-ResourceConfig). The CSI-RS resources provide the UE with the configuration of CSI-RS ports, or CSI-RS port groups, mapped to time and frequency resources (e.g., resource elements (REs)). CSI-RS resources can be zero power (ZP) or non-zero power (NZP) resources. At least one NZP CSI-RS resource may be configured for CM.

For the Type II codebook, the PMI is a linear combination of beams; it has a subset of orthogonal beams to be used for linear combination and has per layer, per polarization, amplitude and phase for each beam. For the PMI of any type, there can be wideband (WB) PMI and/or subband (SB) PMI as configured.

The CSI report configuration may configure the UE for aperiodic, periodic, or semi-persistent CSI reporting. For periodic CSI, the UE may be configured with periodic CSI-RS resources. Periodic CSI on physical uplink control channel (PUCCH) may be triggered via RRC. Semi-persistent CSI reporting on physical uplink control channel (PUCCH) may be activated via a medium access control (MAC) control element (CE). For aperiodic and semi-persistent CSI on the physical uplink shared channel (PUSCH), the BS may signal the UE a CSI report trigger indicating for the UE to send a CSI report for one or more CSI-RS resources, or configuring the CSI-RS report trigger CSI-state (e.g., CSI-Aperiodic TriggerStateList and SemiPersistentOnPUSCH-TriggerStateList). The CSI report trigger for aperiodic CSI and semi-persistent CSI on PUSCH may be provided via downlink control information (DCI).

The UE may report the CSI feedback (CSF) based on the CSI report configuration and the CSI report trigger. For example, the UE may measure the channel on which the triggered CSI-RS resources (associated with the CSI report configuration) is conveyed. Based on the measurements, the UE may select a preferred CSI-RS resource. The UE reports the CSF for the selected CSI-RS resource. LI may be calculated conditioned on the reported CQI, PMI, RI and CRI; CQI may be calculated conditioned on the reported PMI, RI and CRI; PMI may be calculated conditioned on the reported RI and CRI; and RI may be calculated conditioned on the reported CRI.

Each CSI report configuration may be associated with a single downlink (DL) bandwidth part (BWP). The CSI report setting configuration may define a CSI reporting band as a subset of subbands of the BWP. The associated DL BWP may indicated by a higher layer parameter (e.g., bwp-Id) in the CSI report configuration for channel measurement and contains parameter(s) for one CSI reporting band, such as codebook configuration, time-domain behavior, frequency granularity for CSI, measurement restriction configurations, and the CSI-related quantities to be reported by the UE. Each CSI resource setting may be located in the DL BWP identified by the higher layer parameter, and all CSI resource settings may be linked to a CSI report setting have the same DL BWP.

In certain systems, the UE can be configured via higher layer signaling (e.g., in the CSI report configuration) with one out of two possible subband sizes (e.g., reportFreqConfiguration contained in a CSI-ReportConfig) which indicates a frequency granularity of the CSI report, where a subband may be defined as N_{PRB}^{SB} contiguous physical resource blocks (PRBs) and depends on the total number of PRBs in the bandwidth part. The UE may further receive an indication of the subbands for which the CSI feedback is requested. In some examples, a subband mask is configured for the requested subbands for CSI reporting. The UE computes precoders for each requested subband and finds the PMI that matches the computed precoder on each of the subbands.

### Compressed CSI Feedback Coefficient Reporting

As discussed above, a user equipment (UE) may be configured for channel state information (CSI) reporting, for example, by receiving a CSI configuration message from the base station. In certain systems, the UE may be configured to report at least a Type II precoder across configured frequency domain (FD) units. For example, the precoder matrix Wᵣ for layer r includes the W₁ matrix, reporting a subest of selected beams using spatial compression and the W_{2,r} matrix, reporting (for cross-polarization) the linear combination coefficients for the selected beams (2L) across the configured FD units:

$${W}_{r} = {\sum }_{i = 0}^{2 L - 1} {b}_{i} \cdot {c}_{i} , where {c}_{i} = [ {\underbrace{\begin{matrix}{c}_{i , 0} & … & {c}_{i , {N}_{3} - 1}\end{matrix}}}_{{N}_{3}} ] ,$$

where bᵢ is the selected beam, c, is the set of linear combination coefficients (i.e., entries of W_{2,r} matrix), L is the number of selected spatial beams, and N₃ corresponds to the number of frequency units (e.g., subbands, resource blocks (RBs), etc.). In certain configurations, L is RRC configured. The precoder is based on a linear combination of digital Fourier transform (DFT) beams. The Type II codebook may improve MU-MIMO performance. In some configurations considering there are two polarizations, the W_{2,r} matrix has size 2L×N₃, W_{2,r} matrix 510 being the W_{2,r} matrix for layer 0 and W_{2,r} matrix 540 being the W_{2,r} matrix for layer 1.

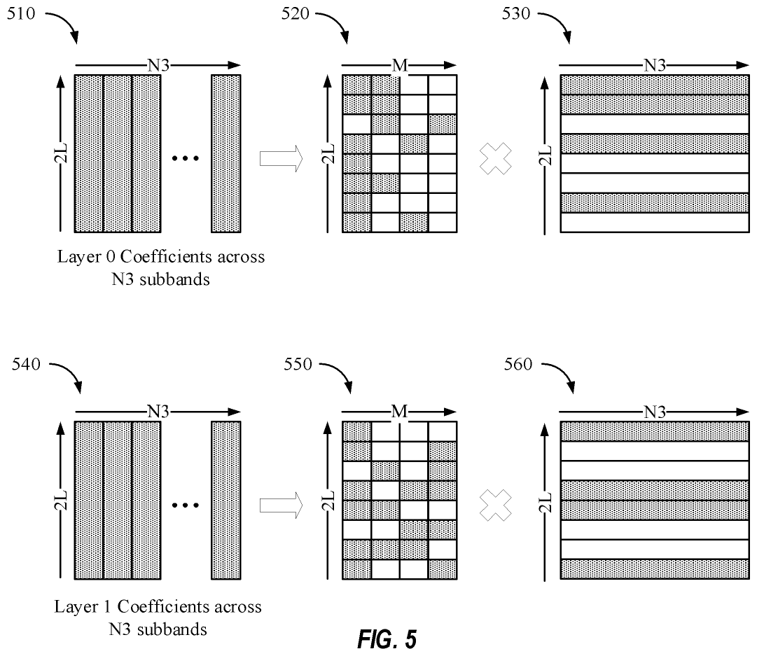

FIG. 5 depicts a conceptual example 500 of precoder matrices. In certain systems, the UE may be configured to report FD compressed precoder feedback to reduce overhead of the CSI report. As shown in conceptual example 500, the precoder matrix (W_{2,i}) for layer i with i=0.1 may use an FD compression

$${W}_{f , i}^{H}$$

matrix to compress the precoder matrix into \tilde{W}_{2,i} matrix size to 2L×M (where M is network configured and communicated in the CSI configuration message via RRC or DCI, and M<N₃) given as:

$${W}_{i} = {W}_{1} {\tilde{W}}_{2 , i} {W}_{f , i}^{H}$$

Where the precoder matrix Wᵢ (not shown) has P=2N₁N₂ rows (spatial domain, number of ports) and N₃ columns (frequency-domain compression unit containing RBs or reporting sub-bands), and where M bases are selected for each of layer 0 and layer 1 independently.

The \tilde{W}_{2,0} matrix 520 consists of the linear combination coefficients (amplitude and co-phasing), where each element represents the coefficient of a tap for a beam. The \tilde{W}_{2,0} matrix 520 as shown is defined by size 2L×M, where one row corresponds to one spatial beam in W₁ (not shown) of size P×2L (where L is network configured via RRC), and one entry therein represents the coefficient of one tap for this spatial beam. The UE may be configured to report (e.g., CSI report) a subset K₀<2 LM of the linear combination coefficients of the \tilde{W}_{2,0} matrix 520. For example, the UE may report K_{NZ,i}<K₀ coefficients (where K_{NZ,i} corresponds to a maximum number of non-zero coefficients for layer-i with i=0 or 1, and K₀ is network configured via RRC) illustrated as shaded squares (unreported coefficients are set to zero). In some configurations, an entry in the \tilde{W}_{2,0} matrix 520 corresponds to a row

$${W}_{f , 0}^{H}$$

of matrix 530. In the example shown, both the \tilde{W}_{2,0} matrix 520 at layer 0 and the \tilde{W}_{2,0} matrix 550 at layer 1 are 2L×M.

The

$${W}_{f , 0}^{H}$$

matrix 350 is composed or the basis vectors (each row is a basis vector) used to perform compression in frequency domain. In the example shown, both

$${W}_{f , 0}^{H}$$

matrix 530 at layer 0 and the

$${W}_{f , 1}^{H}$$

matrix 560 at layer 1 include M=4 FD basis (illustrated as shaded rows) from N₃ candidate DFT basis. In some configurations, the UE may report a subset of selected basis of the

$${W}_{f , i}^{H}$$

matrix via CSI report. Ine M bases specifically selected at layer 0 and layer 1. That is, the M bases selected at layer 0 can be same/partially-overlapped/non-overlapped with the M bases selected at layer 1.

### Overview of UE PMI Codebook-Based CSF

A PMI codebook generally refers to a dictionary of PMI entries. In this way, using a PMI codebook, each PMI component from a pre-defined set can be mapped to bit-sequences reported by a UE. A based station receiving the bit-sequence (as CSF) can then obtain the corresponding PMI from the reported bit-sequence.

How the UE calculates PMI may be left to UE implementation. However, how the UE reports the PMI should follow a format defined in the codebook, so the UE and base station each know how to map PMI components to reported bit-sequences.

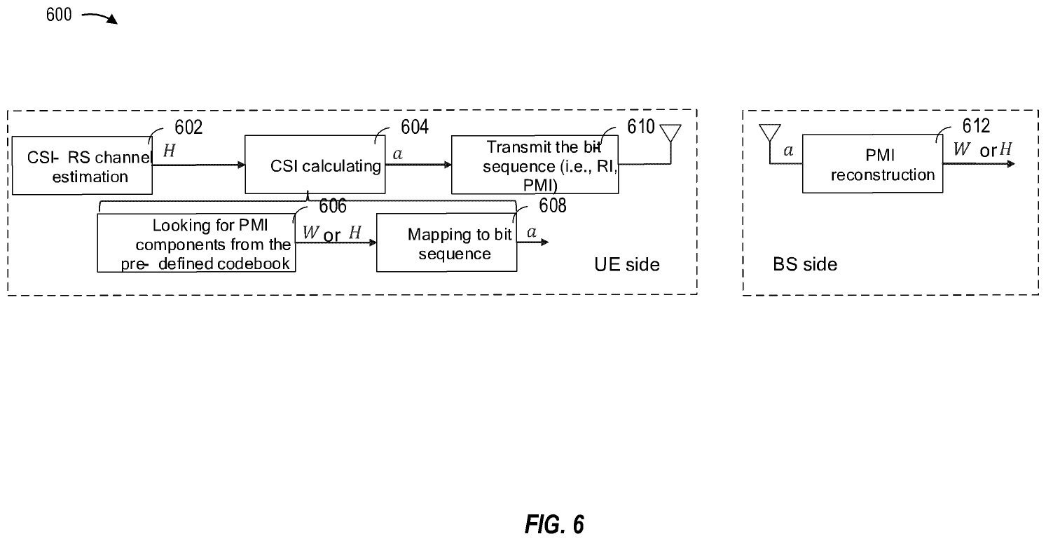

FIG. 6 is a block diagram 600 illustrating an example of codebook based CSF. As illustrated, the UE may first perform channel estimation (at 602) based on CSI-RS to estimate channel H. A CSI calculating block 604 may generate a bit sequence a. As illustrated, bit sequence a may be generated looking for PMI components from the pre-defined PMI codebook for radio channel H or precoder W (at block 606) and mapping the PMI components to the bit sequencea, via block 608. This mapping, from a set of predefined PMI components essentially acts as a form of quantization. The UE transmits the bit sequence a to the BS (e.g., in a CSI report), via block 610.

As illustrated in FIG. 6, at the BS side, the BS receives the bit sequence a reported by the UE. The BS then follows the codebook to obtain each PMI component using the reported bit-sequence a and reconstructs the actual PMI, at block 612, using each PMI component (obtained from the codebook), to recover the radio channel H or precoder W.

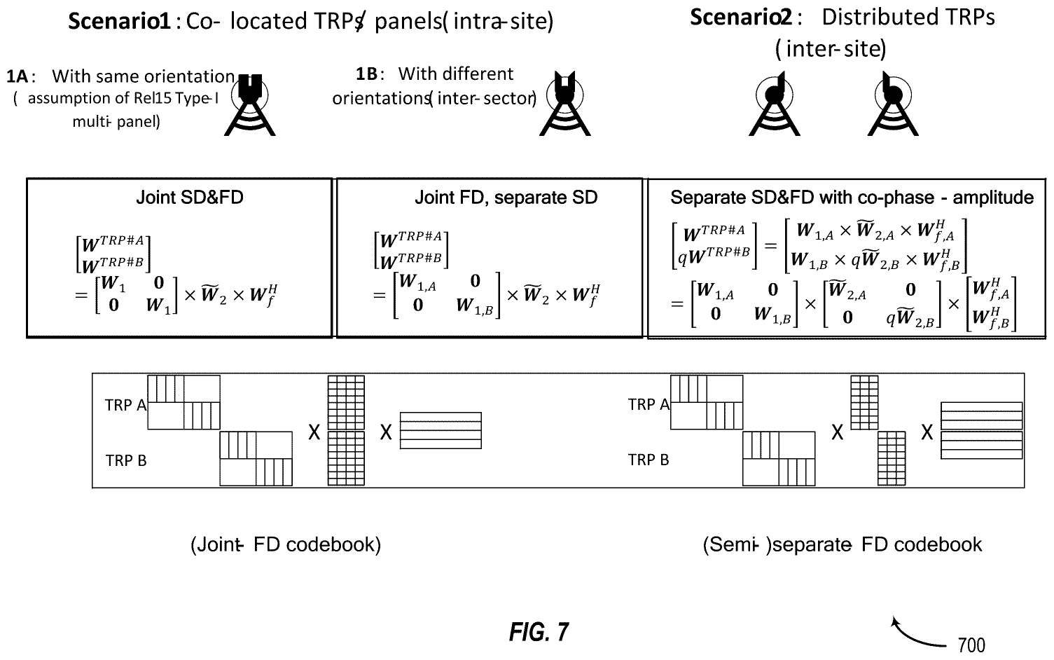

FIG. 7 shows various scenarios 700 for CJT. The scenarios are referred to as Scenario 1A, where co-located TRPs/panes (intra-site) have the same orientation and Scenario 1B, where the panels have different orientations (inter-sector). Another scenario, Scenario 2, may involve Distributed TRPs (inter-site).

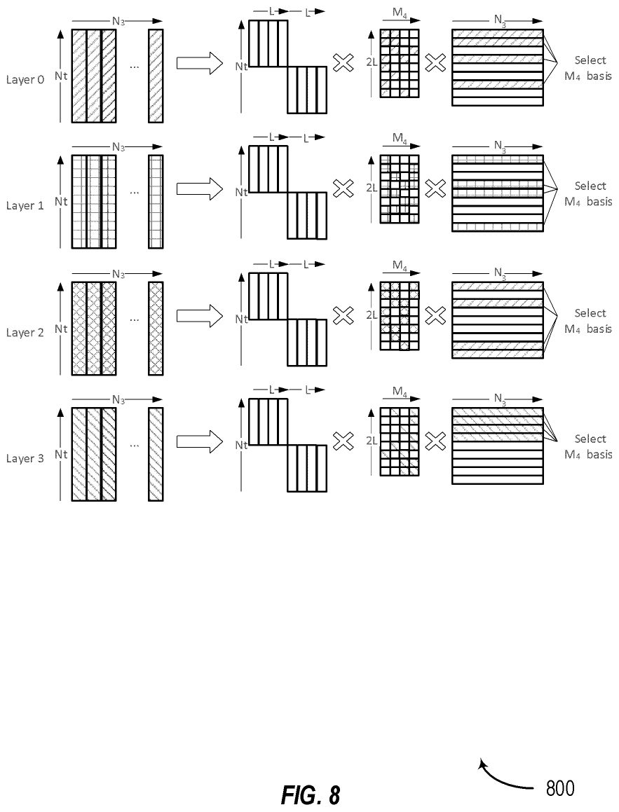

FIG. 8 shows an example 800 for enhanced Type-II (eType-II) CSI where, for each layer, the precoder across a number of N₃ (PMI-)subbands is a Nₜ×N₃ matrix:

$$W : W = {W}_{1} \times {\tilde{W}}_{2} \times {W}_{f}^{H} .$$

where SD bases W₁ (DFT bases) is a Nₜ×2L matrix, W₁ is layer-common, Nₜ=2N₁O₁N₂O₂ (number of Tx antennas—with O₁ and O₂ oversampling) is RRC-configured, L={2,4,6} (number of beams) is RRC-configured FD bases W_{f} (DFT bases) is a M×N₃ matrix, W_{f} is layer-specific, M (number of FD bases) is rank-pair specific, i.e. M₁=M₂ for rank={1,2}, and M₃=M₄ for rank={3,4}, M₁ or M₃ is RRC-configured. Coefficients matrix \tilde{W}₂ is a 2L×M matrix and is layer-specific. For each layer, a UE may report up to K₀ non-zero coefficients, where K₀ is RRC-configured. Across all layers, the UE may report up to 2K, non-zero coefficients, where unreported coefficients may be set to zeros.

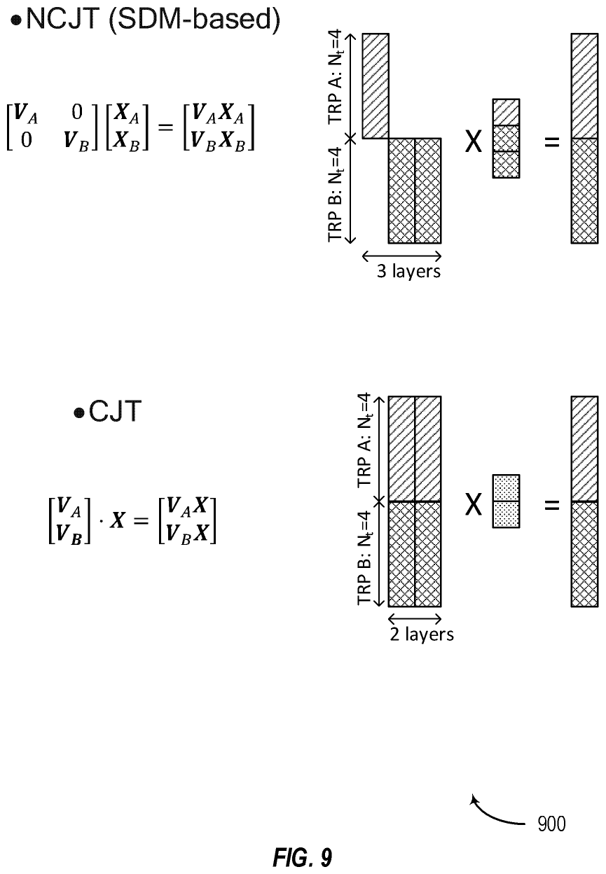

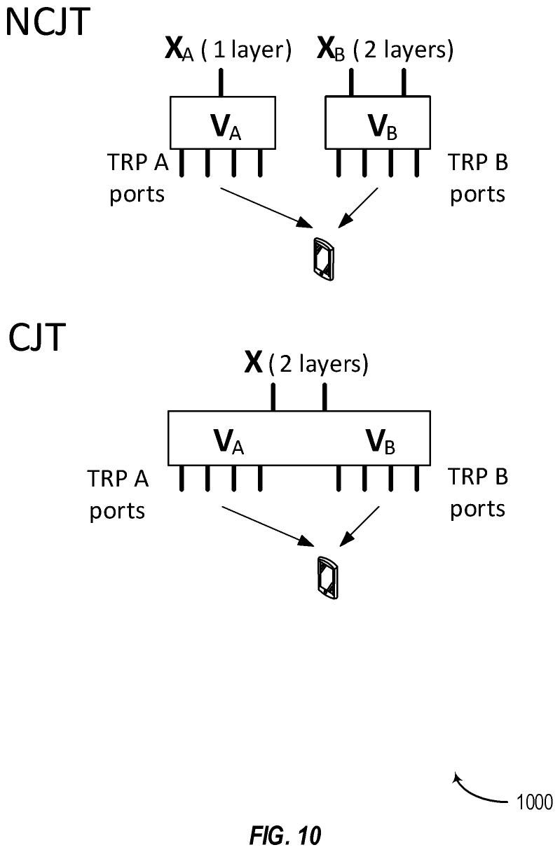

FIG. 9 shows example scenarios 900 for spatial division multiplexed (SDM-based) NCJT, in which data is precoded separately on different TRPs. FIG. 9 also shows an example of CJT, in which data is precoded in a fully-joint way. According to one option, data may be precoded with separate precoder with co-phase and amplitude coefficients. It is also possible that the co-phase/-amplitude is implicitly accommodated into the precoder (thus the equation can appear with no difference from NCJT case). Port diagrams for the NCJT, first option of CJT and second option of CJT, are also illustrated as example scenarios 1000 in FIG. 10.

### Aspects Related to Reporting a Number of SD Bases for Multiple TRPs

According to some techniques, a number of SD bases parameter (Lₙ) may be supported, for example in the context of Type-II codebook refinement for CJT mTRP. A UE may be configured with one or more sets of CSI-RS resources, and the parameter Lₙ may be applicable per CSI-RS. According to some techniques, a value of Lₙ may be configured by a network entity, such as a gNB, for each TRP of a set of TRPs that are to be used to communicate with a UE. However, network configuration may result in less throughput than configuration of the values of Lₙ by a UE. As such, as further described herein, a UE may select (determine, calculate, identify) one or more, or all of the values of Lₙ for the TRPs, which may result in higher throughput in communications between the UE and the network entity via the TRPs. In some cases, the UE may better understand the operating conditions of the UE than a network entity that would otherwise select values of Lₙ. In some examples, a network entity may transmit to the UE an indication of the total number of SD bases across all the TRPs (L or Lₜₒₜ), and the UE may determine the values of Lₙ for each TRP based on the value of L. However, while the UE is aware of what are the values of Lₙ for the TRPs, the base station also should know Lₙ so that the base station can appropriately communicate with the UE via the TRPs.

Additionally, some mechanisms to communicate the values of Lₙ for the TRPs may use an inefficient quantity of bits, increasing communication overhead, for example by CSI reporting messages increasing in size. For example, one approach may be to use ┌log₂ Lₜₒₜ┐ bits to indicate each value of Lₙ, such as for N TRPs. In one example, where Ltot=8 and N=4 TRPs, a total of 4×┌log₂ 8┐=12 bits are needed for all values of Lₙ. According to another example, where Ltot=12 and N=4 TRPs, a total of 4× ┌log₂ 12┐=16 bits are needed for all values of Lₙ. As such, there is a need for efficient techniques to communicate values of Lₙ for TRPs from a UE to a network entity.

Accordingly to some examples, a UE reports a joint indication of N values of Lₙ for TRP n=1, . . . , N, satisfying

$${\sum }_{n = 1}^{N} {L}_{n} = {L}_{tot} ,$$

where Lₜₒₜ is configured by a network entity (e.g., a gNB) and transmitted to the UE. The joint indication has a total number of C (Lₜₒₜ−1, N−1) possible codepoint values (choosing N−1 out of Lₜₒₜ−1). By using such an approach, a fewer number of bits may be used in UCI (e.g., CSI signaling or reporting) communicating the UE-selected values of Lₙ for the TRPs. C(Lₜₒₜ−1, N−1) codepoint values represent all possible combinations of selecting N−1 locations (“split locations” or an accumulated quantity of SD bases) {L_{acc}⁽ⁿ⁾, n=n, . . . ,N−1}, out of all possible Lₜₒₜ−1 locations. Table 1 shows the relationship between split location coordinates L_{acc}⁽ⁿ⁾ (n=n, . . . , N−1) and the number (quantity) of SD bases, Lₙ (n=1, . . . ,N) in the case of encoding (e.g., by a UE, for a UE to send the codepoint to a network entity) and in the case of decoding (e.g., by a network entity):

TABLE 1

| | Encoding | Decoding |
|---|---|---|
| n = 1 | L_{acc}⁽¹⁾ = L₁ − 1 | L₁ = L_{acc}⁽¹⁾ + 1 |
| n = 2, . . . , N − 1 | L_{acc}⁽ⁿ⁾ = L_{acc}⁽ⁿ⁻¹⁾ + Lₙ | Lₙ = L_{acc}⁽ⁿ⁾ − L_{acc}⁽ⁿ⁻¹⁾ |
| n = N | Not applicable | L_{N} = Lₜₒₜ − L_{acc}^{(N-1)} − 1 |

In such example, a total number of bits of ┌log₂ C(Lₜₒₜ−1, N−1)┐ is needed (e.g., is a minimum number of bits that may be used). In some examples, a greater number of bits may be used.

In some examples, to encode the Lₙ report (indicating Lₙ for each TRP of the set of TRPs), the UE may have as input parameters: N; Lₜₒₜ; {Lₙ, n=1, . . . , N such that

$${\sum }_{n = 1}^{N} {L}_{n} = {L}_{tot} \} .$$

The UE may take as an intermediate input one or more accumulated quantity of SD bases, {L_{acc}⁽ⁿ⁾, n=1, . . . , N−1}. The accumulated quantity for a first TRP (n=1) may be L_{acc}⁽ⁿ⁾=L₁−1. The accumulated quantity for a second and subsequent TRPs (n=2, . . . , N−1) may be L_{acc}⁽ⁿ⁾=L_{acc}⁽ⁿ⁻¹⁾+Lₙ. The output (the codepoint that indicates the Lₙ for the set of TRPs) may then be given by

$${\sum }_{n = 1}^{N - 1} C ( {L}_{tot} - 2 - {L}_{acc}^{( n )} , N - n ) .$$

For example, two examples using the above encoding method may have the following indication values:

TABLE 2

| Ln | | | | Lacc(n) | | | |
|---|---|---|---|---|---|---|---|
| L1 | L2 | L3 | LA | Lacc(1) | Lacc(2) | Lacc(3) | Indication |
| 2 | 3 | 2 | 1 | 1 | 4 | 6 | 11 |
| 4 | 2 | 1 | 5 | 3 | 5 | 6 | 49 |

In particular, the first row of Table 2 corresponds to an Example 1, and the second row of Table 2 corresponds to an Example 2, with parameters as follows in Table 3:

TABLE 3

| | N | Ltot | {Ln, n = 1, 2, 3, 4} | {Lacc(n), n = 1, 2, 3} |
|---|---|---|---|---|
| Example 1 | 4 | 8 | {2, 3, 2, 1} | {1, 4, 6} |
| Example 2 | 4 | 12 | {4, 2, 1, 5} | {3, 5, 6} |

Table 4 depicts examples using the above encoding method and corresponding indication values, for the example of N=4 and Lₜₒₜ=8:

TABLE 4

| Ln | | | | Lacc(n) | | | |
|---|---|---|---|---|---|---|---|
| L1 | L2 | L3 | L4 | Lacc(1) | Lacc(2) | Lacc(3) | Indication |
| 1 | 1 | 1 | 5 | 0 | 1 | 2 | 34 |
| 1 | 1 | 2 | 4 | 0 | 1 | 3 | 33 |
| 1 | 1 | 3 | 3 | 0 | 1 | 4 | 32 |
| 1 | 1 | 4 | 2 | 0 | 1 | 5 | 31 |
| 1 | 1 | 5 | 1 | 0 | 1 | 6 | 30 |
| 1 | 2 | 1 | 4 | 0 | 2 | 3 | 29 |
| 1 | 2 | 2 | 3 | 0 | 2 | 4 | 28 |
| 1 | 2 | 3 | 2 | 0 | 2 | 5 | 27 |
| 1 | 2 | 4 | 1 | 0 | 2 | 6 | 26 |
| 1 | 3 | 1 | 3 | 0 | 3 | 4 | 25 |
| 1 | 3 | 2 | 2 | 0 | 3 | 5 | 24 |
| 1 | 3 | 3 | 1 | 0 | 3 | 6 | 23 |
| 1 | 4 | 1 | 2 | 0 | 4 | 5 | 22 |
| 1 | 4 | 2 | 1 | 0 | 4 | 6 | 21 |
| 1 | 5 | 1 | 1 | 0 | 5 | 6 | 20 |
| 2 | 1 | 1 | 4 | 1 | 2 | 3 | 19 |
| 2 | 1 | 2 | 3 | 1 | 2 | 4 | 18 |
| 2 | 1 | 3 | 2 | 1 | 2 | 5 | 17 |
| 2 | 1 | 4 | 1 | 1 | 2 | 6 | 16 |
| 2 | 2 | 1 | 3 | 1 | 3 | 4 | 15 |
| 2 | 2 | 2 | 2 | 1 | 3 | 5 | 14 |
| 2 | 2 | 3 | 1 | 1 | 3 | 6 | 13 |
| 2 | 3 | 1 | 2 | 1 | 4 | 5 | 12 |
| 2 | 3 | 2 | 1 | 1 | 4 | 6 | 11 |
| 2 | 4 | 1 | 1 | 1 | 5 | 6 | 10 |
| 3 | 1 | 1 | 3 | 2 | 3 | 4 | 9 |
| 3 | 1 | 2 | 2 | 2 | 3 | 5 | 8 |
| 3 | 1 | 3 | 1 | 2 | 3 | 6 | 7 |
| 3 | 2 | 1 | 2 | 2 | 4 | 5 | 6 |
| 3 | 2 | 2 | 1 | 2 | 4 | 6 | 5 |
| 3 | 3 | 1 | 1 | 2 | 5 | 6 | 4 |
| 4 | 1 | 1 | 2 | 3 | 4 | 5 | 3 |
| 4 | 1 | 2 | 1 | 3 | 4 | 6 | 2 |
| 4 | 2 | 1 | 1 | 3 | 5 | 6 | 1 |
| 5 | 1 | 1 | 1 | 4 | 5 | 6 | 0 |

Table 5 depicts examples using the above encoding method and corresponding indication values, for the example of N=4 and Lₜₒₜ=12:

TABLE 5

| Ln | | | | Lacc(n) | | | |
|---|---|---|---|---|---|---|---|
| L1 | L2 | L3 | L4 | Lacc(1) | Lacc(2) | Lacc(3) | Indication |
| 1 | 1 | 1 | 9 | 0 | 1 | 2 | 164 |
| 1 | 1 | 2 | 8 | 0 | 1 | 3 | 163 |
| 1 | 1 | 3 | 7 | 0 | 1 | 4 | 162 |
| 1 | 1 | 4 | 6 | 0 | 1 | 5 | 161 |
| 1 | 1 | 5 | 5 | 0 | 1 | 6 | 160 |
| 1 | 1 | 6 | 4 | 0 | 1 | 7 | 159 |
| 1 | 1 | 7 | 3 | 0 | 1 | 8 | 158 |
| 1 | 1 | 8 | 2 | 0 | 1 | 9 | 157 |
| 1 | 1 | 9 | 1 | 0 | 1 | 10 | 156 |
| 1 | 2 | 1 | 8 | 0 | 2 | 3 | 155 |
| 1 | 2 | 2 | 7 | 0 | 2 | 4 | 154 |
| 1 | 2 | 3 | 6 | 0 | 2 | 5 | 153 |
| 1 | 2 | 4 | 5 | 0 | 2 | 6 | 152 |
| 1 | 2 | 5 | 4 | 0 | 2 | 7 | 151 |
| 1 | 2 | 6 | 3 | 0 | 2 | 8 | 150 |
| 1 | 2 | 7 | 2 | 0 | 2 | 9 | 149 |
| 1 | 2 | 8 | 1 | 0 | 2 | 10 | 148 |
| 1 | 3 | 1 | 7 | 0 | 3 | 4 | 147 |
| 1 | 3 | 2 | 6 | 0 | 3 | 5 | 146 |
| 1 | 3 | 3 | 5 | 0 | 3 | 6 | 145 |
| 1 | 3 | 4 | 4 | 0 | 3 | 7 | 144 |
| 1 | 3 | 5 | 3 | 0 | 3 | 8 | 143 |
| 1 | 3 | 6 | 2 | 0 | 3 | 9 | 142 |
| 1 | 3 | 7 | 1 | 0 | 3 | 10 | 141 |
| 1 | 4 | 1 | 6 | 0 | 4 | 5 | 140 |
| 1 | 4 | 2 | 5 | 0 | 4 | 6 | 139 |
| 1 | 4 | 3 | 4 | 0 | 4 | 7 | 138 |
| 1 | 4 | 4 | 3 | 0 | 4 | 8 | 137 |
| 1 | 4 | 5 | 2 | 0 | 4 | 9 | 136 |
| 1 | 4 | 6 | 1 | 0 | 4 | 10 | 135 |
| 1 | 5 | 1 | 5 | 0 | 5 | 6 | 134 |
| 1 | 5 | 2 | 4 | 0 | 5 | 7 | 133 |
| 1 | 5 | 3 | 3 | 0 | 5 | 8 | 132 |
| 1 | 5 | 4 | 2 | 0 | 5 | 9 | 131 |
| 1 | 5 | 5 | 1 | 0 | 5 | 10 | 130 |
| 1 | 6 | 1 | 4 | 0 | 6 | 7 | 129 |
| 1 | 6 | 2 | 3 | 0 | 6 | 8 | 128 |
| 1 | 6 | 3 | 2 | 0 | 6 | 9 | 127 |
| 1 | 6 | 4 | 1 | 0 | 6 | 10 | 126 |
| 1 | 7 | 1 | 3 | 0 | 7 | 8 | 125 |
| 1 | 7 | 2 | 2 | 0 | 7 | 9 | 124 |
| 1 | 7 | 3 | 1 | 0 | 7 | 10 | 123 |
| 1 | 8 | 1 | 2 | 0 | 8 | 9 | 122 |
| 1 | 8 | 2 | 1 | 0 | 8 | 10 | 121 |
| 1 | 9 | 1 | 1 | 0 | 9 | 10 | 120 |
| 2 | 1 | 1 | 8 | 1 | 2 | 3 | 119 |
| 2 | 1 | 2 | 7 | 1 | 2 | 4 | 118 |
| 2 | 1 | 3 | 6 | 1 | 2 | 5 | 117 |
| 2 | 1 | 4 | 5 | 1 | 2 | 6 | 116 |
| 2 | 1 | 5 | 4 | 1 | 2 | 7 | 115 |
| 2 | 1 | 6 | 3 | 1 | 2 | 8 | 114 |
| 2 | 1 | 7 | 2 | 1 | 2 | 9 | 113 |
| 2 | 1 | 8 | 1 | 1 | 2 | 10 | 112 |
| 2 | 2 | 1 | 7 | 1 | 3 | 4 | 111 |
| 2 | 2 | 2 | 6 | 1 | 3 | 5 | 110 |
| 2 | 2 | 3 | 5 | 1 | 3 | 6 | 109 |
| 2 | 2 | 4 | 4 | 1 | 3 | 7 | 108 |
| 2 | 2 | 5 | 3 | 1 | 3 | 8 | 107 |
| 2 | 2 | 6 | 2 | 1 | 3 | 9 | 106 |
| 2 | 2 | 7 | 1 | 1 | 3 | 10 | 105 |
| 2 | 3 | 1 | 6 | 1 | 4 | 5 | 104 |
| 2 | 3 | 2 | 5 | 1 | 4 | 6 | 103 |
| 2 | 3 | 3 | 4 | 1 | 4 | 7 | 102 |
| 2 | 3 | 4 | 3 | 1 | 4 | 8 | 101 |
| 2 | 3 | 5 | 2 | 1 | 4 | 9 | 100 |
| 2 | 3 | 6 | 1 | 1 | 4 | 10 | 99 |
| 2 | 4 | 1 | 5 | 1 | 5 | 6 | 98 |
| 2 | 4 | 2 | 4 | 1 | 5 | 7 | 97 |
| 2 | 4 | 3 | 3 | 1 | 5 | 8 | 96 |
| 2 | 4 | 4 | 2 | 1 | 5 | 9 | 95 |
| 2 | 4 | 5 | 1 | 1 | 5 | 10 | 94 |
| 2 | 5 | 1 | 4 | 1 | 6 | 7 | 93 |
| 2 | 5 | 2 | 3 | 1 | 6 | 8 | 92 |
| 2 | 5 | 3 | 2 | 1 | 6 | 9 | 91 |
| 2 | 5 | 4 | 1 | 1 | 6 | 10 | 90 |
| 2 | 6 | 1 | 3 | 1 | 7 | 8 | 89 |
| 2 | 6 | 2 | 2 | 1 | 7 | 9 | 88 |
| 2 | 6 | 3 | 1 | 1 | 7 | 10 | 87 |
| 2 | 7 | 1 | 2 | 1 | 8 | 9 | 86 |
| 2 | 7 | 2 | 1 | 1 | 8 | 10 | 85 |
| 2 | 8 | 1 | 1 | 1 | 9 | 10 | 84 |
| 3 | 1 | 1 | 7 | 2 | 3 | 4 | 83 |
| 3 | 1 | 2 | 6 | 2 | 3 | 5 | 82 |
| 3 | 1 | 3 | 5 | 2 | 3 | 6 | 81 |
| 3 | 1 | 4 | 4 | 2 | 3 | 7 | 80 |
| 3 | 1 | 5 | 3 | 2 | 3 | 8 | 79 |
| 3 | 1 | 6 | 2 | 2 | 3 | 9 | 78 |
| 3 | 1 | 7 | 1 | 2 | 3 | 10 | 77 |
| 3 | 2 | 1 | 6 | 2 | 4 | 5 | 76 |
| 3 | 2 | 2 | 5 | 2 | 4 | 6 | 75 |
| 3 | 2 | 3 | 4 | 2 | 4 | 7 | 74 |
| 3 | 2 | 4 | 3 | 2 | 4 | 8 | 73 |
| 3 | 2 | 5 | 2 | 2 | 4 | 9 | 72 |
| 3 | 2 | 6 | 1 | 2 | 4 | 10 | 71 |
| 3 | 3 | 1 | 5 | 2 | 5 | 6 | 70 |
| 3 | 3 | 2 | 4 | 2 | 5 | 7 | 69 |
| 3 | 3 | 3 | 3 | 2 | 5 | 8 | 68 |
| 3 | 3 | 4 | 2 | 2 | 5 | 9 | 67 |
| 3 | 3 | 5 | 1 | 2 | 5 | 10 | 66 |
| 3 | 4 | 1 | 4 | 2 | 6 | 7 | 65 |
| 3 | 4 | 2 | 3 | 2 | 6 | 8 | 64 |
| 3 | 4 | 3 | 2 | 2 | 6 | 9 | 63 |
| 3 | 4 | 4 | 1 | 2 | 6 | 10 | 62 |
| 3 | 5 | 1 | 3 | 2 | 7 | 8 | 61 |
| 3 | 5 | 2 | 2 | 2 | 7 | 9 | 60 |
| 3 | 5 | 3 | 1 | 2 | 7 | 10 | 59 |
| 3 | 6 | 1 | 2 | 2 | 8 | 9 | 58 |
| 3 | 6 | 2 | 1 | 2 | 8 | 10 | 57 |
| 3 | 7 | 1 | 1 | 2 | 9 | 10 | 56 |
| 4 | 1 | 1 | 6 | 3 | 4 | 5 | 55 |
| 4 | 1 | 2 | 5 | 3 | 4 | 6 | 54 |
| 4 | 1 | 3 | 4 | 3 | 4 | 7 | 53 |
| 4 | 1 | 4 | 3 | 3 | 4 | 8 | 52 |
| 4 | 1 | 5 | 2 | 3 | 4 | 9 | 51 |
| 4 | 1 | 6 | 1 | 3 | 4 | 10 | 50 |
| 4 | 2 | 1 | 5 | 3 | 5 | 6 | 49 |
| 4 | 2 | 2 | 4 | 3 | 5 | 7 | 48 |
| 4 | 2 | 3 | 3 | 3 | 5 | 8 | 47 |
| 4 | 2 | 4 | 2 | 3 | 5 | 9 | 46 |
| 4 | 2 | 5 | 1 | 3 | 5 | 10 | 45 |
| 4 | 3 | 1 | 4 | 3 | 6 | 7 | 44 |
| 4 | 3 | 2 | 3 | 3 | 6 | 8 | 43 |
| 4 | 3 | 3 | 2 | 3 | 6 | 9 | 42 |
| 4 | 3 | 4 | 1 | 3 | 6 | 10 | 41 |
| 4 | 4 | 1 | 3 | 3 | 7 | 8 | 40 |
| 4 | 4 | 2 | 2 | 3 | 7 | 9 | 39 |
| 4 | 4 | 3 | 1 | 3 | 7 | 10 | 38 |
| 4 | 5 | 1 | 2 | 3 | 8 | 9 | 37 |
| 4 | 5 | 2 | 1 | 3 | 8 | 10 | 36 |
| 4 | 6 | 1 | 1 | 3 | 9 | 10 | 35 |
| 5 | 1 | 1 | 5 | 4 | 5 | 6 | 34 |
| 5 | 1 | 2 | 4 | 4 | 5 | 7 | 33 |
| 5 | 1 | 3 | 3 | 4 | 5 | 8 | 32 |
| 5 | 1 | 4 | 2 | 4 | 5 | 9 | 31 |
| 5 | 1 | 5 | 1 | 4 | 5 | 10 | 30 |
| 5 | 2 | 1 | 4 | 4 | 6 | 7 | 29 |
| 5 | 2 | 2 | 3 | 4 | 6 | 8 | 28 |
| 5 | 2 | 3 | 2 | 4 | 6 | 9 | 27 |
| 5 | 2 | 4 | 1 | 4 | 6 | 10 | 26 |
| 5 | 3 | 1 | 3 | 4 | 7 | 8 | 25 |
| 5 | 3 | 2 | 2 | 4 | 7 | 9 | 24 |
| 5 | 3 | 3 | 1 | 4 | 7 | 10 | 23 |
| 5 | 4 | 1 | 2 | 4 | 8 | 9 | 22 |
| 5 | 4 | 2 | 1 | 4 | 8 | 10 | 21 |
| 5 | 5 | 1 | 1 | 4 | 9 | 10 | 20 |
| 6 | 1 | 1 | 4 | 5 | 6 | 7 | 19 |
| 6 | 1 | 2 | 3 | 5 | 6 | 8 | 18 |
| 6 | 1 | 3 | 2 | 5 | 6 | 9 | 17 |
| 6 | 1 | 4 | 1 | 5 | 6 | 10 | 16 |
| 6 | 2 | 1 | 3 | 5 | 7 | 8 | 15 |
| 6 | 2 | 2 | 2 | 5 | 7 | 9 | 14 |
| 6 | 2 | 3 | 1 | 5 | 7 | 10 | 13 |
| 6 | 3 | 1 | 2 | 5 | 8 | 9 | 12 |
| 6 | 3 | 2 | 1 | 5 | 8 | 10 | 11 |
| 6 | 4 | 1 | 1 | 5 | 9 | 10 | 10 |
| 7 | 1 | 1 | 3 | 6 | 7 | 8 | 9 |
| 7 | 1 | 2 | 2 | 6 | 7 | 9 | 8 |
| 7 | 1 | 3 | 1 | 6 | 7 | 10 | 7 |
| 7 | 2 | 1 | 2 | 6 | 8 | 9 | 6 |
| 7 | 2 | 2 | 1 | 6 | 8 | 10 | 5 |
| 7 | 3 | 1 | 1 | 6 | 9 | 10 | 4 |
| 8 | 1 | 1 | 2 | 7 | 8 | 9 | 3 |
| 8 | 1 | 2 | 1 | 7 | 8 | 10 | 2 |
| 8 | 2 | 1 | 1 | 7 | 9 | 10 | 1 |
| 9 | 1 | 1 | 1 | 8 | 9 | 10 | 0 |

In some examples, to decode the Lₙ report (indicating Lₙ for each TRP of the set of TRPs), the network entity (e.g., gNB may have as input parameters: N; Lₜₒₜ; and the indication (the codepoint that indicates the Lₙ for the set of TRPs). As an intermediate output, the network entity may generate {L_{acc}(n), n=1, . . . , N−1}, with algorithm procedure:

```
s₀=0;
For n=1, . . . ,N−1
  Find the largest x* ∈ {N − 1 − n, ... , Lₜₒₜ − 1 − n} in table 5.2.2.2.5-4 such
  that
  Indication−sₙ₋₁ ≥ C(x*, N − n);
  eₙ = C(x*, N − n);
  sₙ = sₙ₋₁ + eₙ;
  L_{acc}⁽ⁿ⁾ = Lₜₒₜ − 2 − x*;
```

According to the described algorithm procedure, the output: Ln, n=1, . . . , N may be, for L1=Lacc(1)+1, for Ln=Lacc(n)−Lacc(n−1), n=2, . . . , N−1, and LN−Ltot−Lacc(N−1)−1.

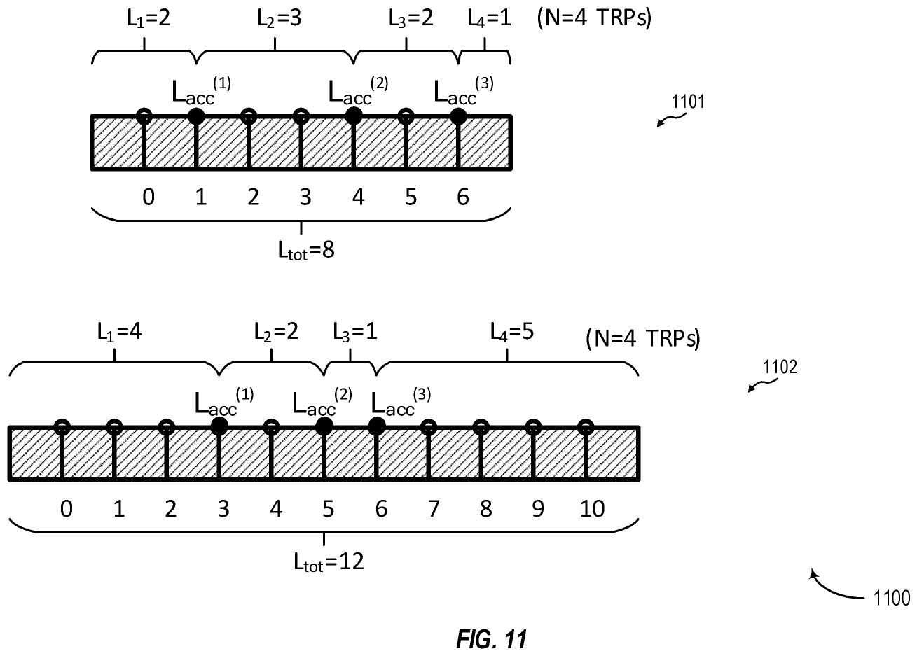

FIG. 11 depicts example diagrams 1100 of location coordinates for SD bases. In some examples, diagrams 1100 may support reporting a number of spatial domain bases for multiple transmission reception points. Diagrams 1100 include a first diagram 1101 and a second diagrams 1102.

In the example of first diagram 1101, where Ltot=8 and N=4 TRPs, C(Lₜₒₜ−1,N−1) codepoint values represent the possible combinations of selecting N−1=3 locations, {L_{acc}⁽ⁿ⁾, n=1, 2, 3}, out of all possible Lₜₒₜ−1=7 locations. The location coordinates are 0,1, . . . , Lₜₒₜ−2=6, and the corresponding split locations may be L_{acc}⁽ⁿ⁾=1,4,6 for n=1, . . . , N−1-3, respectively. According to this example, 6 bits may be needed for the UE to communicate all the values of Lₙ for the TRPs. By contrast, a larger number of bits (e.g., 12) may have been needed according to other techniques.

In the example of second diagram 1102, where Ltot=12 and N=4 TRPs, C(Lₜₒₜ−1, N−1) codepoint values represent the possible combinations of selecting N−1=3 locations, {L_{acc}⁽ⁿ⁾, n=1, 2, 3}, out of all possible Lₜₒₜ−1=11 locations. The location coordinates are 0,1, . . . , Lₜₒₜ−2=10, and the corresponding split locations may be L_{acc}⁽ⁿ⁾=3,5,6 for n=1, . . . , N−1=3, respectively. According to this example, 8 bits may be needed for the UE to communicate all the values of Lₙ for the TRPs. By contrast, a larger number of bits (e.g., 16) may have been needed according to other techniques.

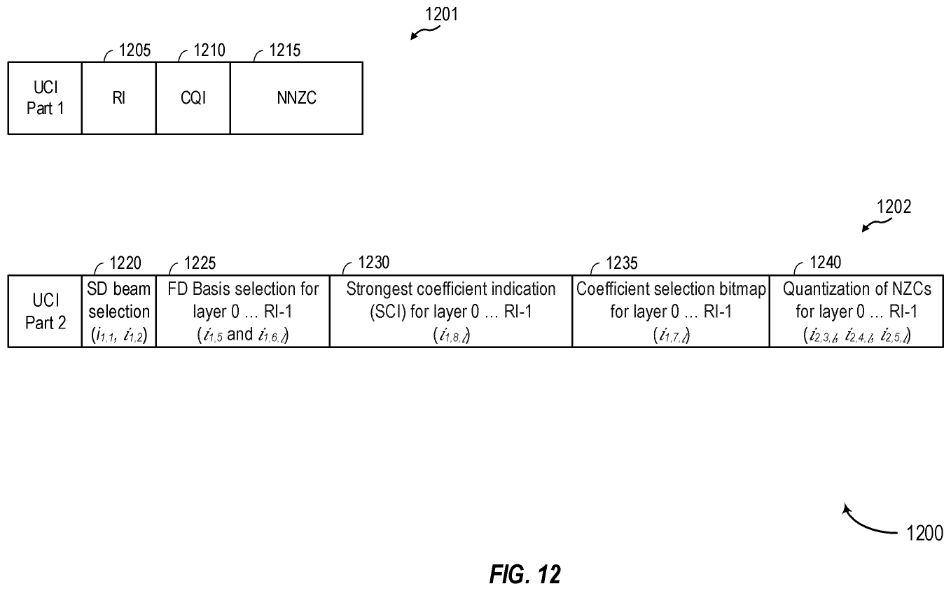

FIG. 12 depicts a block diagram of uplink control information (UCI) signaling 1200. In some examples, UCI signaling 1200 may support reporting a number of spatial domain bases for multiple transmission reception points.

In some examples, UCI signaling 1200 may be CSI signaling (e.g., a CSI report or other channel state feedback (CSF)) and have multiple parts, such as a first UCI part 1201 (e.g., a first CSI part) and a second UCI part 1202 (e.g., a second CSI part). For example, CSI signaling (which may also be referred to as a CSI report or CSI message) may have a large payload size. In some examples, the payload may also vary in size, for example depending on the communication configuration for the UE, number of layers, rank, number of SD bases, number of FD bases, and so on. As such, the UCI signaling 1200 may have a first UCI part 1201 having a fixed payload size, and a second UCI part 1202 having a variable payload size. In some examples, the first UCI part 1201 may have a smaller payload size than the second UCI part 1202. In some examples, the first UCI part 1201 may be transmitted with a higher reliability (e.g., using a smaller index Modulation and Coding Scheme (MCS) or other encoding type, or on time, frequency, and/or spatial resources associated with higher reliability communications) have a smaller payload size than the second UCI part 1202.

In some examples, first UCI part 1201 may include a portion (bits or fields) to convey a RI 1205, CQI 1210, and a number of non-zero coefficients (NZC) (NNZC) 1215. NNZC 1215 may be used to indicate a total number of NZC across all layers K_{NZ}^{tot}, and have a bitwidth of log₂ 2K₀ bits. A network entity (e.g., gNB) receiving the UCI signaling 1200 may be able to determine the payload size of the second UCI part 1202 based on one or more features of the first UCI part 1201. The payload size of the second UCI part 1202 may be based on the RI 1205, CQI 1210, and/or NNZC 1215. For example, a combination of the RI 1205 (conveying a rank indicator or number of layers) and the NNZC 1215 may map to a particular payload size, and the network entity may determine a size of the second UCI part 1202 based on these features of the first UCI part 1201.

In some examples, second UCI part 1202 may include a portion (bits or fields) to convey a SD beam selection 1220, FD beam selection 1225, strongest coefficient indication (SCI) 1230, coefficient selection bitmap 1235, and a quantization of NZCs 1240. SD beam selection 1220 may be used to indicate the L beams out of N₁N₂O₁O₂ total beams and have a bitwidth of i_{1,1}: log₂ O₁O₂ for beam group, and i_{1,2}:

$$⌈ {log}_{2} ( \begin{matrix}{N}_{1} {N}_{2} \\ L\end{matrix} ) ⌉$$

for beam indication. FD beam selection 1225 may be used to select M_{R1} FD bases for each layer out of N₃ bases and have a bitwidth that depends on N₃. For N₃≤19, a UE may only report i_{1,6,l} with l=0, . . . RI−1 using

$$⌈ {log}_{2} ( \begin{matrix}{N}_{3} - 1 \\ {M}_{RI} - 1\end{matrix} ) ⌉ \times RI bits .$$

For N₃≥19, the bitwidth may be a window-based two-stage selection. SCI 1230 may be used to indicate a location of strongest coefficients and have a bitwidth that depends on the RI. For RI=1, the bitwidth may be

$$⌈ {log}_{2} {K}_{NZ}^{tot} ⌉ - bit .$$

For RI′>1, the bitwidth may be ┌log₂ 2L┐×RI-bit. Coefficient selection bitmap 1235 for layer 0 . . . . RI−1 may be used to indicate the location of NZCs within \tilde{W}_{2,l} and a bitwidth of RI size-2LM bitmaps, and a total of 2 LM×RI bits. The quantization of NZCs 1240 may be used to indicate an amplitude and/or phase quantization and have bitwidth as follows: for i_{2,3,l}:4-bit, ref amp weaker polarization, for i_{2,4,l}:

$$( {K}_{NZ}^{tot} - RI ) \times 3 bit ,$$

diff amp for each coefficient other than the strongest coefficient, and for i_{2,5,l}:

$$( {K}_{NZ}^{tot} - RI ) \times 4 bit ,$$

phase for each coefficient other than the strongest coefficient.

The first UCI part 1201 depicts RI 1205, CQI 1210, and NNZC 1215 in one order. In other examples a different order may be used consistent with the techniques described herein. Similarly, the second UCI part 1202 depicts SD beam selection 1220, FD beam selection 1225, SCI 1230, coefficient selection bitmap 1235, and a quantization of NZCs 1240 in one order. In other examples a different order may be used consistent with the techniques described herein.

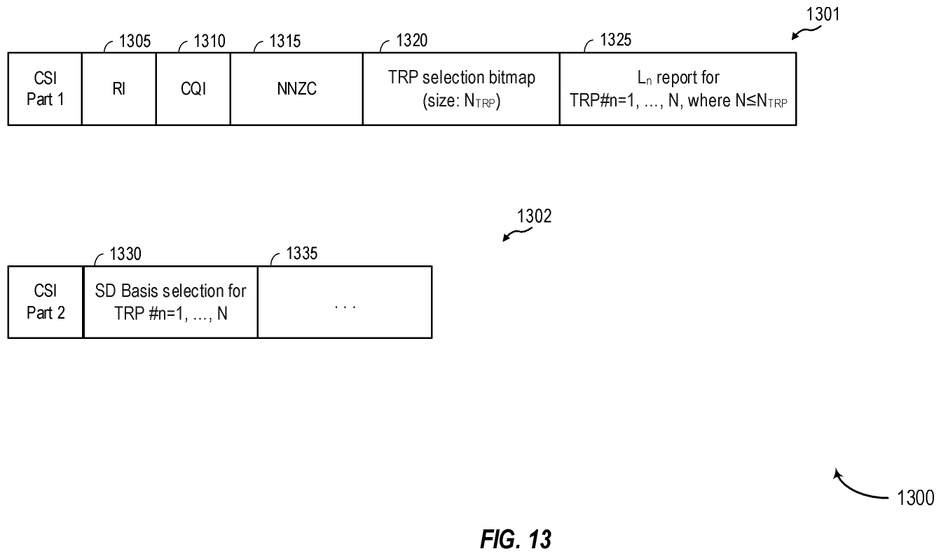

FIG. 13 depicts a block diagram of CSI signaling 1300. In some examples, CSI signaling 1300 may support reporting a number of spatial domain bases for multiple transmission reception points. In some examples, CSI signaling 1300 may be a specific example of UCI signaling.

In some examples, CSI signaling 1300 (e.g., a CSI report or other channel state feedback (CSF)) may have multiple parts, such as a first CSI part 1301 and a second CSI part 1302. CSI signaling 1300 may have a first CSI part 1301 having a fixed payload size, and a second CSI part 1302 having a variable payload size. In some examples, the first CSI part 1301 may have a smaller payload size than the second CSI part 1302. In some examples, the first CSI part 1301 may be transmitted with a higher reliability (e.g., using a smaller index MCS or other encoding type, or on time, frequency, and/or spatial resources associated with higher reliability communications) have a smaller payload size than the second CSI part 1302.

In some examples, first CSI part 1301 may include a portion (bits or fields) to convey a RI 1305, CQI 1310, and NNZC 1315, which may be examples of RI 1205, CQI 1210, and NNZC 1215 described herein.

In some examples, TRP selection bitmap 1320 may be an optional field of first CSI part 1301. TRP selection bitmap 1320 may have a size of N_{TRP}, a number of TRPs out of which a UE is allowed to select, if the UE is allowed to make such selection. For example, this field exists if NE {1, . . . , N_{TRP}} is allowed to be selected out of N_{TRP} TRPs by a UE. Alternatively, this field does not exist if a restricted configuration N=N_{TRP} is configured by the network entity, and no TRP selection by the UE is allowed by the network entity. In some examples, even if optional TRP selection bitmap 1320 is omitted, Lₙ report 1325 may still be included in first CSI part 1301.

Lₙ report 1325 is a field of first CSI part 1301. In some examples, the bit size of Lₙ report 1325 may be based on (determined by) N_{TRP} (e.g., as opposed to based on N alone), for example, the bit size needed can be larger: max_{N∈{1, . . . ,N}_{_{TRP}}_{}}┌log₂ C(Lₜₒₜ−1, N−1)┐ bits than simply ┌log₂ C (Lₜₒₜ−1, N−1)┐ bits; In some examples, this larger number of bits may also be obtained when N=N_{TRP}, i.e. max_{N∈{1, . . . ,N}_{_{TRP}}_{}} log₂ C(Lₜₒₜ−1, N−1)=┌log₂ C(Lₜₒₜ−1, N_{TRP}−1)┐ bits. As discussed here, a bit size of first CSI part 1301 may be of a fixed size (e.g., predetermined and known to the UE and network entity (e.g., gNB), for example before the UE is aware of the reported N by decoding TRP selection bitmap 1320.

In some examples, Lₙ report 1325 may have a particular size that is fixed. For some values of N, only a portion of the Lₙ report 1325 may be used. In one example, N is conveyed using the most significant bits (MSBs) of Lₙ report 1325 when less than all bits of Lₙ report 1325 are needed. In one example, N is conveyed using the least significant bits (LSBs) of Lₙ report 1325 when less than all bits of Lₙ report 1325 are needed. In some example, padding (e.g., zero padding) may be added to Lₙ report 1325 in addition to the MSBs or LSBs used to convey the indication of Lₙ in Lₙ report 1325.

In an example, the Lₙ report 1325 may be sized as 6 bits. For example, Ltot=8 and N_{TRP}=4, and N=3 TRPs are selected. In such example, ┌log₂ C(8−1, 3−1)┐=5 bits may be reported in the ┌log₂ C(8−1, 4−1)┐=6-bit size field, Lₙ report 1325.

In another example, the Lₙ report 1325 may be sized as 2 bits. For example, where Ltot=4 and N_{TRP}=4, and N=N_{TRP}=4 TRPs are selected, then it may not be necessary for the UE to report each value of Lₙ for the TRPs. For example, because it is only possible that L1=L2=L3=L4=1, and ┌log₂ C(4−1, 3−1)┐=┌log₂ C(4−1, 2−1)┐=2-bit size may be reserved for Lₙ report 1325, for example in case 3 TRPs or 2 TRPs are selected.

Additionally, all zeros for Lₙ report 1325 may be used to correspond to a particular codepoint indicating values of Lₙ for the TRPs. For example, if N=1 TRP (a single TRP (sTRP) is selected by the UE, Lₙ report 1325 may not need to indicate anything, but the size of the field may be greater than zero bits, for example so that first CSI part 1301 may have a fixed size.

Second CSI part 1302 may include at least SD basis selection 1330, an indication of the SD basis selection for each TRP #1, . . . , N, respectively. log₂ O₁O₂ for the SD basis group of each one TRP #n=1, . . . , N. In some examples, the bit size for each one of TRP #n=1, . . . , N may be

$$⌈ {log}_{2} ( \begin{matrix}{N}_{1} {N}_{2} \\ {L}_{n}\end{matrix} ) ⌉ .$$

In some examples, second CSI part 1302 may include one or more additional fields 1335, such as FD beam selection 1225, SCI 1230, coefficient selection bitmap 1235, and a quantization of NZCs 1240, as described with reference to second UCI part 1202.

In some examples, with Lₙ reported in Lₙ report 1325, first CSI part 1301 may support indicating a TRP-specific number of FD bases selected (denoted as M_{v,n}, where v denotes rank, and n denotes TRP #n. In such case, the network entity may configure (transmit an indication to the UE) of a single My value, based on which, each TRP's M_{v,n} is proportional to each Lₙ. For example, more beams (SD bases) may mean more delay paths (FD bases).

In one example the value of M_{v,n} of each TRP is determined based on a maximum value of Lₙ. For example, denote L_{n,max}=max_{n∈{1, . . . ,N}}Lₙ, then for TRP #n: M_{v,n}=┌Mᵥ·Lₙ/L_{n,max}┐ or ┌Mᵥ·Lₙ/L_{n, max}┐.

In one example the value of M_{v,n} of each TRP is determined based on the value of Lₜₒₜ. For example, for TRP #n: M_{v,n}=┌Mᵥ·Lₙ/Lₜₒₜ┐ or ┌Mᵥ·Lₙ/Lₜₒₜ┐.

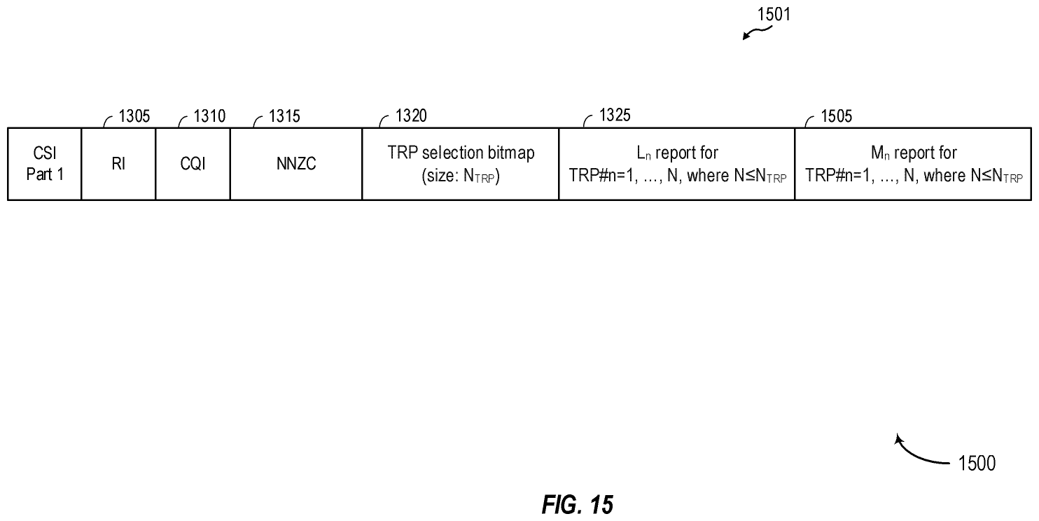

FIG. 15 depicts a block diagram of CSI signaling 1500. In some examples, CSI signaling 1500 may support reporting a number of spatial domain bases for multiple transmission reception points. In some examples, CSI signaling 1500 may be a specific example of UCI signaling.

CSI signaling 1500 may have multiple parts, such as a first CSI part 1501. In some examples, first CSI part 1501 may include a RI 1305, CQI 1310, NNZC 1315, TRP selection bitmap 1320, and Lₙ report 1325 as described herein with reference to CSI signaling 1300. CSI signaling 1500 may also include a second CSI part (not shown). In one example the value of M_{v,n} of each TRP may be reported. For example, CSI signaling 1500 may include Mₙ report 1505.

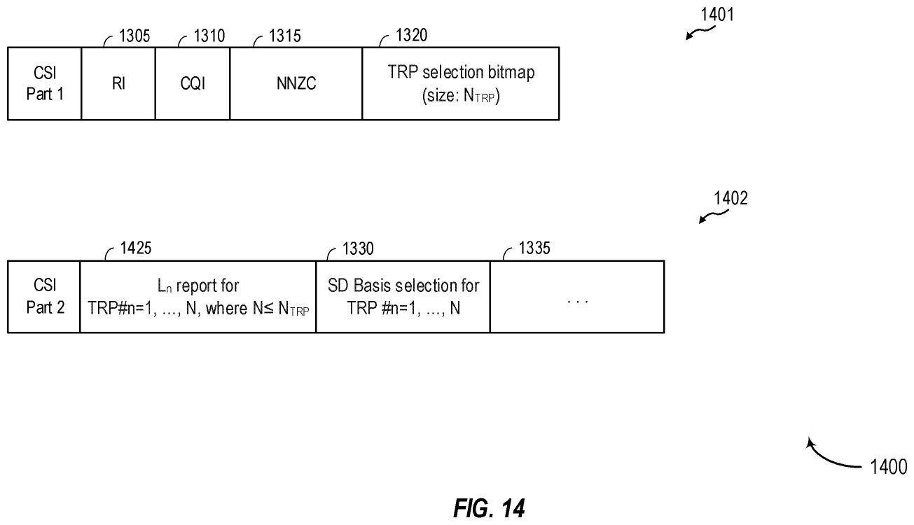

FIG. 14 depicts a block diagram of CSI signaling 1400. In some examples, CSI signaling 1400 may support reporting a number of spatial domain bases for multiple transmission reception points. In some examples, CSI signaling 1400 may be a specific example of UCI signaling.

CSI signaling 1400 may have multiple parts, such as a first CSI part 1401 and a second CSI part 1402. In some examples, first CSI part 1401 may include a RI 1305, CQI 1310, NNZC 1315, and TRP selection bitmap 1320, as described herein, and second CSI part 1402 may include Lₙ report 1425, SD basis selection 1330, and optionally one or more additional fields 1335.

For the example of CSI signaling 1400, the bit size of the Lₙ report 1425 field of second CSI part 1402 may be determined based on N, as ┌log₂ C(Lₜₒₜ−1, N−1)┐ bits. In some examples however, the network entity may not need the TRP selection bitmap 1320, for example because the size would be zero for some values of N. For example, if N=1 sTRP selected, there is no need to report Lₙ and TRP selection bitmap 1320 may be omitted. In another example, if NN₁N₂≤Lₜₒₜ (total ports of N TRPs no larger than Lₜₒₜ, e.g., for smaller N cases like N=1 or 2), thus all NN₁N₂ SD bases of all N selected TRPs should be selected, and TRP selection bitmap 1320 may be omitted.

In some examples, the bit size of the SD basis selection 1330 may be determined by an Lₙ value maximizing C(N₁N₂,Lₙ), for example maximized as

$$C ( {N}_{1} {N}_{2} , \frac{{N}_{1} {N}_{2}}{2} )$$

by

$$\frac{{N}_{1} {N}_{2}}{2} .$$

In some examples, the bit size for the SD basis selection 1330 by may be based on this Lₙ value maximizing C(N₁N₂,Lₙ) e.g. determined as

$$⌈ {log}_{2} ( \begin{matrix}{N}_{1} {N}_{2} \\ {N}_{1} {N}_{2} / 2\end{matrix} ) ⌉ bits ,$$

rather than based on the actual reported Lₙ value e.g. determined as

$$⌈ {log}_{2} ( \begin{matrix}{N}_{1} {N}_{2} \\ {L}_{n}\end{matrix} ) ⌉ bits ,$$

such as in Lₙ report 1425. In some case, the size of the second CSI part 1402 may be determined after the first CSI part 1401 is decoded by the network entity (e.g., gNB), for example with reference to CSI signaling 1300. However, for CSI signaling 1300, the first CSI part 1401 omits an Lₙ report (where Lₙ report 1425 is in second CSI part 1402).

Similar to the discussion herein with reference to CSI signaling 1300, for certain values of Lₙ reported according to Lₙ report 1425 field, a portion (subset, subportion) of the SD basis selection 1330 field bit size may be used (e.g. MSBs or LSBs), and zero-padding may be used.

In some examples, the second CSI part 1402 may include at least SD basis selection 1330, an indication of the SD basis selection for each TRP #1, . . . , N, respectively. log₂ O₁O₂ for the SD basis group of each one TRP #n=1, . . . , N. In some examples, the bit size for each one of TRP #n=1, . . . , N may be

$$⌈ {log}_{2} ( \begin{matrix}{N}_{1} {N}_{2} \\ {N}_{1} {N}_{2} / 2\end{matrix} ) ⌉ .$$

In some examples, second CSI part 1402 may include one or more additional fields 1335, such as FD beam selection 1225, SCI 1230, coefficient selection bitmap 1235, and a quantization of NZCs 1240, as described with reference to second UCI part 1202.

In some examples described herein, for a reported Lₙ value, it may be invalid to report Lₙ>N₁N₂, where N₁N₂ is the number of ports per TRP (and per polarization).

In some examples described herein, the actual reported total SD bases may be smaller than the configured Lₜₒₜ. For example if total number of ports for all selected TRPs is smaller than Lₜₒₜ (NN₁N₂≤Lₜₒₜ), then L_{tot,actual}=min(NN₁N₂,Lₜₒₜ).

In some examples described herein, a maximum quantity of non-zero coefficients (NZCs) K₀ may be determined based on the configured Lₜₒₜ: K₀=β2LₜₒₜM, even if the actually quantity of selected SD bases L_{tot,actual}=min(NN₁N₂,Lₜₒₜ)<Lₜₒₜ. In the above equation, β∈(0,1) is a configured factor to determine K₀, and M is a TRP-common quantity of selected FD bases.

In some examples described herein, a maximum quantity of non-zero coefficients (NZCs) K₀ may be determined based on the actually quantity of selected SD bases L_{tot,actual}=min(NN₁N₂,Lₜₒₜ): K₀=β2LₜₒₜM, where β∈(0,1) is a configured factor to determine K₀, and M is a TRP-common quantity of selected FD bases.

### Example Operations of User Equipment

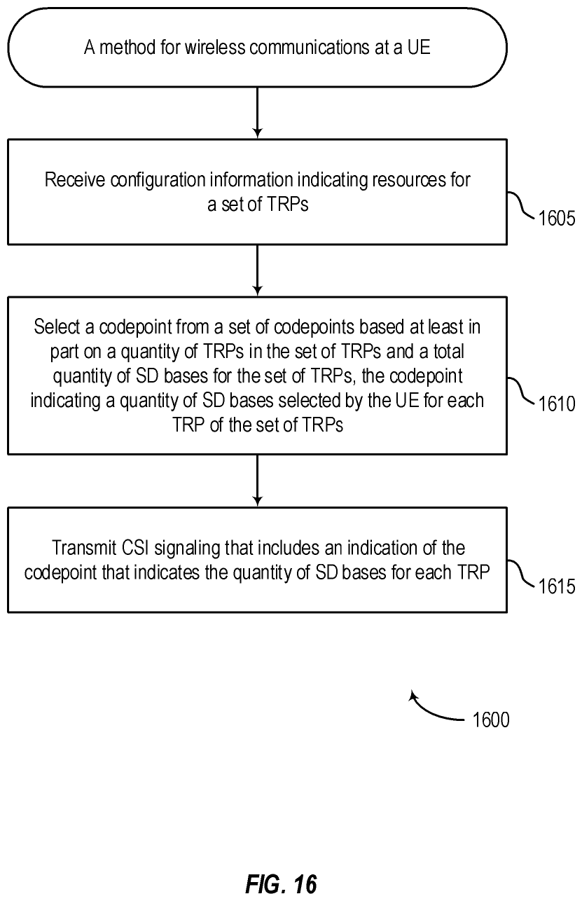

FIG. 16 shows an example of a method 1600 of wireless communication at a UE, such as at a UE 104 of FIGS. 1 and 3.

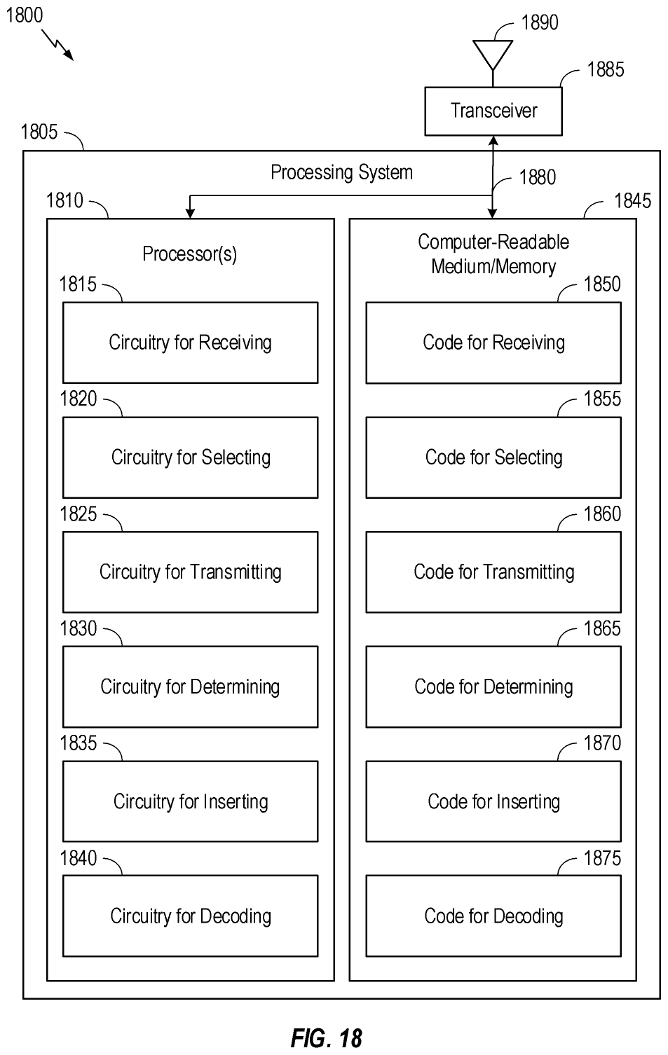

Method 1600 begins at step 1605 with receiving configuration information indicating resources for a set of TRPs. In some cases, the operations of this step refer to, or may be performed by, circuitry for receiving and/or code for receiving as described with reference to FIG. 18.

Method 1600 then proceeds to step 1610 with selecting a codepoint from a set of codepoints based at least in part on a quantity of TRPs in the set of TRPs and a total quantity of SD bases for the set of TRPs, the codepoint indicating a quantity of SD bases selected by the UE for each TRP of the set of TRPs. In some cases, the operations of this step refer to, or may be performed by, circuitry for selecting and/or code for selecting as described with reference to FIG. 18.

Method 1600 then proceeds to step 1615 with transmitting CSI signaling that includes an indication of the codepoint that indicates the quantity of SD bases for each TRP. In some cases, the operations of this step refer to, or may be performed by, circuitry for transmitting and/or code for transmitting as described with reference to FIG. 18.

In some aspects, transmitting the channel state information signaling comprises: transmitting a first CSI part of the CSI signaling that includes the indication of the codepoint that indicates the quantity of SD bases for each TRP; and transmitting, based at least in part on the first CSI part, a second CSI part of the CSI signaling that indicates a selected SD basis for each TRP.

In some aspects, the method 1600 further includes determining an accumulated quantity of SD bases corresponding to the set of TRPs, wherein the codepoint is based at least in part on the accumulated quantity of SD bases. In some cases, the operations of this step refer to, or may be performed by, circuitry for selecting and/or code for selecting as described with reference to FIG. 18.

In some aspects, the method 1600 further includes receiving an indication of a total quantity of FD bases for the set of TRPs. In some cases, the operations of this step refer to, or may be performed by, circuitry for receiving and/or code for receiving as described with reference to FIG. 18.

In some aspects, the method 1600 further includes determining, for each TRP of the set of TRPs, a quantity of FD bases for the TRP based at least in part on the total quantity of FD bases, the quantity of SD bases selected by the UE for the TRP, and a maximum quantity of SD bases from the quantity of SD bases selected by the UE for the set of TRPs. In some cases, the operations of this step refer to, or may be performed by, circuitry for determining and/or code for determining as described with reference to FIG. 18.

In some aspects, the method 1600 further includes receiving an indication of a total quantity of FD bases for the set of TRPs. In some cases, the operations of this step refer to, or may be performed by, circuitry for receiving and/or code for receiving as described with reference to FIG. 18.

In some aspects, the method 1600 further includes determining, for each TRP of the set of TRPs, a quantity of FD bases for the TRP based at least in part on the total quantity of FD bases, the quantity of SD bases selected by the UE for the TRP, and the total quantity of SD bases for the set of TRPs. In some cases, the operations of this step refer to, or may be performed by, circuitry for determining and/or code for determining as described with reference to FIG. 18.

In some aspects, transmitting the first CSI part of the CSI message further comprises: transmitting, in the first CSI part for each TRP of the set of TRPs, an indication of a quantity of FD bases for the TRP.

In some aspects, the method 1600 further includes determining a quantity of bits based at least in part on a maximum number of TRPs in the set of TRPs for the indication of the codepoint to be transmitted in the first CSI part of the CSI signaling. In some cases, the operations of this step refer to, or may be performed by, circuitry for determining and/or code for determining as described with reference to FIG. 18.

In some aspects, the method 1600 further includes selecting a subset of the bits for the indication of the codepoint based at least in part on the quantity of bits being less than a bit size of a field of the CSI signaling. In some cases, the operations of this step refer to, or may be performed by, circuitry for selecting and/or code for selecting as described with reference to FIG. 18.

In some aspects, the method 1600 further includes inserting zero-padding for a remaining quantity of bits of the field. In some cases, the operations of this step refer to, or may be performed by, circuitry for inserting and/or code for inserting as described with reference to FIG. 18.

In some aspects, the quantity of TRPs in the set of TRPs is one, transmitting the CSI signaling comprises refraining from transmitting in the field of the CSI signaling for the indication of the codepoint.

In some aspects, transmitting the channel state information signaling comprises: transmitting a first CSI part of the CSI signaling; and transmitting, based at least in part on the first CSI part, a second CSI part of the CSI signaling that includes the indication of the codepoint that indicates the quantity of SD bases for each TRP and that indicates a selected SD basis for each TRP.

In some aspects, a bit size for a field of the second CSI part that comprises the indication of the codepoint is based at least in part on the quantity of TRPs in the set of TRPs.

In some aspects, a bit size for a field of the second CSI part that that indicates a selected SD basis for each TRP is based at least in part on half of a total quantity of ports per TRP and per polarization.

In some aspects, the method 1600 further includes determining whether the quantity of SD bases selected by the UE is greater than a total quantity of ports per TRP and per polarization, wherein the CSI signaling is transmitted based at least in part on determining that the quantity of SD bases is not greater than the total quantity. In some cases, the operations of this step refer to, or may be performed by, circuitry for determining and/or code for determining as described with reference to FIG. 18.

In some aspects, a sum of the quantities of SD bases selected by the UE is less than the total quantity of SD bases for the set of TRPs, based at least in part on a quantity of ports for the set of TRPs is less than the total quantity of SD bases for the set of TRPs.

In some aspects, the method 1600 further includes determining a maximum number of non-zero coefficients based at least in part on the total quantity of SD bases for the set of TRPs. In some cases, the operations of this step refer to, or may be performed by, circuitry for determining and/or code for determining as described with reference to FIG. 18.

In some aspects, the method 1600 further includes determining a maximum number of non-zero coefficients based at least in part on the sum of the quantities of SD bases selected by the UE. In some cases, the operations of this step refer to, or may be performed by, circuitry for determining and/or code for determining as described with reference to FIG. 18.

In some aspects, the method 1600 further includes receiving data signaling via the set of TRPs. In some cases, the operations of this step refer to, or may be performed by, circuitry for receiving and/or code for receiving as described with reference to FIG. 18.

In some aspects, the method 1600 further includes decoding the received data signaling based the quantity of SD bases for each TRP. In some cases, the operations of this step refer to, or may be performed by, circuitry for decoding and/or code for decoding as described with reference to FIG. 18.

In some aspects, the method 1600 further includes receiving CSI-RSs from the set of TRPs, wherein the CSI signaling includes one or more of a CQI, a RI, a NNZC that are based at least in part on the received CSI-RSs. In some cases, the operations of this step refer to, or may be performed by, circuitry for receiving and/or code for receiving as described with reference to FIG. 18.

In some aspects, the CSI signaling comprises a first CSI part that has a fixed size and a second CSI part that has a size that is based at least in part on the first CSI part.

In one aspect, method 1600, or any aspect related to it, may be performed by an apparatus, such as communications device 1800 of FIG. 18, which includes various components operable, configured, or adapted to perform the method 1600.

Communications device 1800 is described below in further detail.

Note that FIG. 16 is just one example of a method, and other methods including fewer, additional, or alternative steps are possible consistent with this disclosure.

### Example Operations of a Network Entity

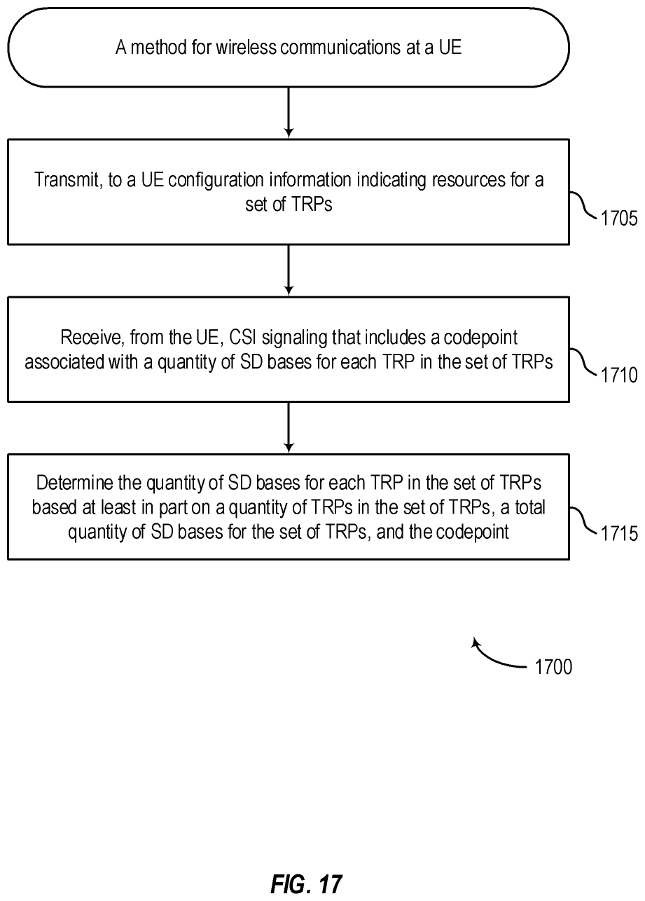

FIG. 17 shows an example of a method 1700 of wireless communication at a network entity, such as at a BS 102 of FIGS. 1 and 3, or at a disaggregated base station as discussed with respect to FIG. 2.

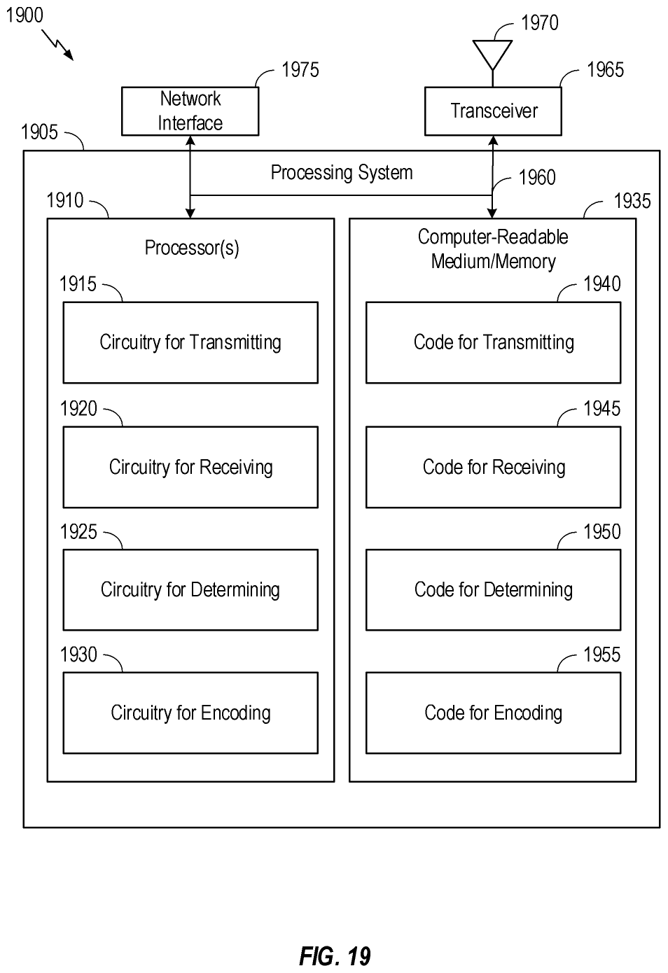

Method 1700 begins at step 1705 with transmitting, to a UE configuration information indicating resources for a set of TRPs. In some cases, the operations of this step refer to, or may be performed by, circuitry for transmitting and/or code for transmitting as described with reference to FIG. 19.

Method 1700 then proceeds to step 1710 with receiving, from the UE, CSI signaling that includes a codepoint associated with a quantity of SD bases for each TRP in the set of TRPs. In some cases, the operations of this step refer to, or may be performed by, circuitry for receiving and/or code for receiving as described with reference to FIG. 19.

Method 1700 then proceeds to step 1715 with determining the quantity of SD bases for each TRP in the set of TRPs based at least in part on a quantity of TRPs in the set of TRPs, a total quantity of SD bases for the set of TRPs, and the codepoint. In some cases, the operations of this step refer to, or may be performed by, circuitry for determining and/or code for determining as described with reference to FIG. 19.

In some aspects, receiving the CSI signaling comprises: receiving a first CSI part of the CSI signaling that includes the indication of the codepoint that indicates the quantity of SD bases for each TRP; and receiving, based at least in part on the first CSI part, a second CSI part of the CSI signaling that indicates a selected SD basis for each TRP.

In some aspects, receiving the channel state information signaling comprises: receiving a first CSI part of the CSI signaling; and receiving, based at least in part on the first CSI part, a second CSI part of the CSI signaling that includes the indication of the codepoint that indicates the quantity of SD bases for each TRP and that indicates a selected SD basis for each TRP.

In some aspects, a bit size for a field of the second CSI part that comprises the indication of the codepoint is based at least in part on the quantity of TRPs in the set of TRPs.

In some aspects, a bit size for a field of the second CSI part that that indicates a selected SD basis for each TRP is based at least in part on half of a total quantity of ports per TRP and per polarization.

In some aspects, the method 1700 further includes encoding data signaling based the quantity of SD bases for each TRP. In some cases, the operations of this step refer to, or may be performed by, circuitry for encoding and/or code for encoding as described with reference to FIG. 19.

In some aspects, the method 1700 further includes transmitting the data signaling via the set of TRPs. In some cases, the operations of this step refer to, or may be performed by, circuitry for transmitting and/or code for transmitting as described with reference to FIG. 19.

In one aspect, method 1700, or any aspect related to it, may be performed by an apparatus, such as communications device 1900 of FIG. 19, which includes various components operable, configured, or adapted to perform the method 1700.

Communications device 1900 is described below in further detail.

Note that FIG. 17 is just one example of a method, and other methods including fewer, additional, or alternative steps are possible consistent with this disclosure.

### Example Communications Devices

FIG. 18 depicts aspects of an example communications device 1800. In some aspects, communications device 1800 is a user equipment, such as a UE 104 described above with respect to FIGS. 1 and 3.

The communications device 1800 includes a processing system 1805 coupled to the transceiver 1885 (e.g., a transmitter and/or a receiver). The transceiver 1885 is configured to transmit and receive signals for the communications device 1800 via the antenna 1890, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1845 via a bus 1880. In certain aspects, the computer-readable medium/memory 1845 is configured to store instructions (e.g., computer-executable code) that when executed by the one or more processors 1810, cause the one or more processors 1810 to perform the method 1600 described with respect to FIG. 16, or any aspect related to it. Note that reference to a processor performing a function of communications device 1800 may include one or more processors 1810 performing that function of communications device 1800.

In the depicted example, computer-readable medium/memory 1845 stores code (e.g., executable instructions), such as code for receiving 1850, code for selecting 1855, code for transmitting 1860, code for determining 1865, code for inserting 1870, and code for decoding 1875. Processing of the code for receiving 1850, code for selecting 1855, code for transmitting 1860, code for determining 1865, code for inserting 1870, and code for decoding 1875 may cause the communications device 1800 to perform the method 1600 described with respect to FIG. 16, or any aspect related to it.

The one or more processors 1810 include circuitry configured to implement (e.g., execute) the code stored in the computer-readable medium/memory 1845, including circuitry such as circuitry for receiving 1815, circuitry for selecting 1820, circuitry for transmitting 1825, circuitry for determining 1830, circuitry for inserting 1835, and circuitry for decoding 1840. Processing with circuitry for receiving 1815, circuitry for selecting 1820, circuitry for transmitting 1825, circuitry for determining 1830, circuitry for inserting 1835, and circuitry for decoding 1840 may cause the communications device 1800 to perform the method 1600 described with respect to FIG. 16, or any aspect related to it.

Various components of the communications device 1800 may provide means for performing the method 1600 described with respect to FIG. 16, or any aspect related to it. For example, means for transmitting, sending or outputting for transmission may include transceivers 354 and/or antenna(s) 352 of the UE 104 illustrated in FIG. 3 and/or the transceiver 1885 and the antenna 1890 of the communications device 1800 in FIG. 18. Means for receiving or obtaining may include transceivers 354 and/or antenna(s) 352 of the UE 104 illustrated in FIG. 3 and/or the transceiver 1885 and the antenna 1890 of the communications device 1800 in FIG. 18.

FIG. 19 depicts aspects of an example communications device 1900. In some aspects, communications device 1900 is a network entity, such as BS 102 of FIGS. 1 and 3, or a disaggregated base station as discussed with respect to FIG. 2.

The communications device 1900 includes a processing system 1905 coupled to the transceiver 1965 (e.g., a transmitter and/or a receiver) and/or a network interface 1975. The transceiver 1965 is configured to transmit and receive signals for the communications device 1900 via the antenna 1970, such as the various signals as described herein. The network interface 1975 is configured to obtain and send signals for the communications device 1900 via communication link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to a computer-readable medium/memory 1935 via a bus 1960. In certain aspects, the computer-readable medium/memory 1935 is configured to store instructions (e.g., computer-executable code) that when executed by the one or more processors 1910, cause the one or more processors 1910 to perform the method 1700 described with respect to FIG. 17, or any aspect related to it. Note that reference to a processor of communications device 1900 performing a function may include one or more processors 1910 of communications device 1900 performing that function.

In the depicted example, the computer-readable medium/memory 1935 stores code (e.g., executable instructions), such as code for transmitting 1940, code for receiving 1945, code for determining 1950, and code for encoding 1955. Processing of the code for transmitting 1940, code for receiving 1945, code for determining 1950, and code for encoding 1955 may cause the communications device 1900 to perform the method 1700 described with respect to FIG. 17, or any aspect related to it.

The one or more processors 1910 include circuitry configured to implement (e.g., execute) the code stored in the computer-readable medium/memory 1935, including circuitry such as circuitry for transmitting 1915, circuitry for receiving 1920, circuitry for determining 1925, and circuitry for encoding 1930. Processing with circuitry for transmitting 1915, circuitry for receiving 1920, circuitry for determining 1925, and circuitry for encoding 1930 may cause the communications device 1900 to perform the method 1700 described with respect to FIG. 17, or any aspect related to it.

Various components of the communications device 1900 may provide means for performing the method 1700 described with respect to FIG. 17, or any aspect related to it. Means for transmitting, sending or outputting for transmission may include transceivers 332 and/or antenna(s) 334 of the BS 102 illustrated in FIG. 3 and/or the transceiver 1965 and the antenna 1970 of the communications device 1900 in FIG. 19. Means for receiving or obtaining may include transceivers 332 and/or antenna(s) 334 of the BS 102 illustrated in FIG. 3 and/or the transceiver 1965 and the antenna 1970 of the communications device 1900 in FIG. 19.

### Example Clauses

Implementation examples are described in the following numbered clauses:

Clause 1: A method for wireless communications at a UE, comprising: receiving configuration information indicating resources for a set of TRPs; selecting a codepoint from a set of codepoints based at least in part on a quantity of TRPs in the set of TRPs and a total quantity of SD bases for the set of TRPs, the codepoint indicating a quantity of SD bases selected by the UE for each TRP of the set of TRPs; and transmitting CSI signaling that includes an indication of the codepoint that indicates the quantity of SD bases for each TRP.

Clause 2: The method of Clause 1, wherein transmitting the channel state information signaling comprises: transmitting a first CSI part of the CSI signaling that includes the indication of the codepoint that indicates the quantity of SD bases for each TRP; and transmitting, based at least in part on the first CSI part, a second CSI part of the CSI signaling that indicates a selected SD basis for each TRP.

Clause 3: The method of Clause 2, further comprising: receiving an indication of a total quantity of FD bases for the set of TRPs; and determining, for each TRP of the set of TRPs, a quantity of FD bases for the TRP based at least in part on the total quantity of FD bases, the quantity of SD bases selected by the UE for the TRP, and a maximum quantity of SD bases from the quantity of SD bases selected by the UE for the set of TRPs.

Clause 4: The method of Clause 2, further comprising: receiving an indication of a total quantity of FD bases for the set of TRPs; and determining, for each TRP of the set of TRPs, a quantity of FD bases for the TRP based at least in part on the total quantity of FD bases, the quantity of SD bases selected by the UE for the TRP, and the total quantity of SD bases for the set of TRPs.

Clause 5: The method of Clause 2, wherein transmitting the first CSI part of the CSI message further comprises: transmitting, in the first CSI part for each TRP of the set of TRPs, an indication of a quantity of FD bases for the TRP.

Clause 6: The method of Clause 2, further comprising: determining a quantity of bits based at least in part on a maximum number of TRPs in the set of TRPs for the indication of the codepoint to be transmitted in the first CSI part of the CSI signaling; selecting a subset of the bits for the indication of the codepoint based at least in part on the quantity of bits being less than a bit size of a field of the CSI signaling; and inserting zero-padding for a remaining quantity of bits of the field.

Clause 7: The method of Clause 2, wherein the quantity of TRPs in the set of TRPs is one, transmitting the CSI signaling comprises refraining from transmitting in the field of the CSI signaling for the indication of the codepoint.

Clause 8: The method of any one of Clauses 1-7, wherein transmitting the channel state information signaling comprises: transmitting a first CSI part of the CSI signaling; and transmitting, based at least in part on the first CSI part, a second CSI part of the CSI signaling that includes the indication of the codepoint that indicates the quantity of SD bases for each TRP and that indicates a selected SD basis for each TRP.

Clause 9: The method of Clause 8, wherein a bit size for a field of the second CSI part that comprises the indication of the codepoint is based at least in part on the quantity of TRPs in the set of TRPs.

Clause 10: The method of Clause 8, wherein a bit size for a field of the second CSI part that that indicates a selected SD basis for each TRP is based at least in part on half of a total quantity of ports per TRP and per polarization.

Clause 11: The method of any one of Clauses 1-10, further comprising: determining whether the quantity of SD bases selected by the UE is greater than a total quantity of ports per TRP and per polarization, wherein the CSI signaling is transmitted based at least in part on determining that the quantity of SD bases is not greater than the total quantity.

Clause 12: The method of any one of Clauses 1-11, wherein a sum of the quantities of SD bases selected by the UE is less than the total quantity of SD bases for the set of TRPs, based at least in part on a quantity of ports for the set of TRPs is less than the total quantity of SD bases for the set of TRPs.

Clause 13: The method of any one of Clauses 1-12, further comprising: receiving data signaling via the set of TRPs; and decoding the received data signaling based the quantity of SD bases for each TRP.

Clause 14: The method of any one of Clauses 1-13, further comprising: receiving CSI-RSs from the set of TRPs, wherein the CSI signaling includes one or more of a CQI, a RI, a NNZC that are based at least in part on the received CSI-RSs.

Clause 15: The method of any one of Clauses 1-14, wherein the CSI signaling comprises a first CSI part that has a fixed size and a second CSI part that has a size that is based at least in part on the first CSI part.

Clause 16: The method of any one of Clauses 1-15, further comprising: determining an accumulated quantity of SD bases corresponding to the set of TRPs, wherein the codepoint is based at least in part on the accumulated quantity of SD bases.

Clause 17: The method of any one of Clauses 1-16, further comprising: determining a maximum number of non-zero coefficients based at least in part on the total quantity of SD bases for the set of TRPs.

Clause 18: The method of any one of Clauses 1-17, further comprising: determining a maximum number of non-zero coefficients based at least in part on the sum of the quantities of SD bases selected by the UE.

Clause 19: A method for wireless communications at a network entity, comprising: transmitting, to a UE configuration information indicating resources for a set of TRPs; receiving, from the UE, CSI signaling that includes a codepoint associated with a quantity of SD bases for each TRP in the set of TRPs; and determining the quantity of SD bases for each TRP in the set of TRPs based at least in part on a quantity of TRPs in the set of TRPs, a total quantity of SD bases for the set of TRPs, and the codepoint.

Clause 20: The method of Clause 19, wherein receiving the CSI signaling comprises: receiving a first CSI part of the CSI signaling that includes the indication of the codepoint that indicates the quantity of SD bases for each TRP; and receiving, based at least in part on the first CSI part, a second CSI part of the CSI signaling that indicates a selected SD basis for each TRP.

Clause 21: The method of any one of Clauses 19 and 20, wherein receiving the channel state information signaling comprises: receiving a first CSI part of the CSI signaling; and receiving, based at least in part on the first CSI part, a second CSI part of the CSI signaling that includes the indication of the codepoint that indicates the quantity of SD bases for each TRP and that indicates a selected SD basis for each TRP.

Clause 22: The method of Clause 21, wherein a bit size for a field of the second CSI part that comprises the indication of the codepoint is based at least in part on the quantity of TRPs in the set of TRPs.

Clause 23: The method of Clause 21, wherein a bit size for a field of the second CSI part that that indicates a selected SD basis for each TRP is based at least in part on the indicated quantity of SD bases selected by the UE.

Clause 24: The method of any one of Clauses 19-23, further comprising: encoding data signaling based the quantity of SD bases for each TRP; and transmitting the data signaling via the set of TRPs.

Clause 25: An apparatus, comprising: a memory comprising executable instructions; and a processor configured to execute the executable instructions and cause the apparatus to perform a method in accordance with any one of Clauses 1-24.

Clause 26: An apparatus, comprising means for performing a method in accordance with any one of Clauses 1-24.

Clause 27: A non-transitory computer-readable medium comprising executable instructions that, when executed by a processor of an apparatus, cause the apparatus to perform a method in accordance with any one of Clauses 1-24.

Clause 28: A computer program product embodied on a computer-readable storage medium comprising code for performing a method in accordance with any one of Clauses 1-24.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications at a user equipment (UE), comprising:
receiving configuration information indicating resources for a set of transmission reception points (TRPs);
selecting a codepoint from a set of codepoints based at least in part on a quantity of TRPs in the set of TRPs and a total quantity of spatial domain (SD) bases for the set of TRPs, the codepoint indicating a quantity of SD bases selected by the UE for each TRP of the set of TRPs; and
transmitting channel state information (CSI) signaling that includes an indication of the codepoint that indicates the quantity of SD bases selected by the UE for each TRP.

2. The method of claim 1, further comprising:
determining an accumulated quantity of SD bases corresponding to the set of TRPs, wherein the codepoint is based at least in part on the accumulated quantity of SD bases.

3. The method of claim 1, wherein transmitting the CSI signaling comprises:
transmitting a first CSI part of the CSI signaling that includes the indication of the codepoint that indicates the quantity of SD bases for each TRP and that further includes an indication of a quantity of frequency domain (FD) bases for each TRP; and
transmitting, based at least in part on the first CSI part, a second CSI part of the CSI signaling that indicates a selected SD basis for each TRP.

4. The method of claim 3, further comprising:
receiving an indication of a total quantity of frequency domain (FD) bases for the set of TRPs; and
determining, for each TRP of the set of TRPs, a quantity of FD bases for the TRP based at least in part on
the total quantity of FD bases,
the quantity of SD bases selected by the UE for the TRP, and further based on one of:
a maximum quantity of SD bases from the quantity of SD bases selected by the UE for the set of TRPs, or
the total quantity of SD bases for the set of TRPs.

5. (canceled)

6. (canceled)

7. The method of claim 3, further comprising:
determining a quantity of bits based at least in part on a maximum number of TRPs in the set of TRPs for the indication of the codepoint to be transmitted in the first CSI part of the CSI signaling; and
selecting a subset of the bits for the indication of the codepoint based at least in part on the quantity of bits being less than a bit size of a field of the CSI signaling.

8. (canceled)

9. The method of claim 1, wherein transmitting the CSI signaling comprises:
transmitting a first CSI part of the CSI signaling; and
transmitting, based at least in part on the first CSI part, a second CSI part of the CSI signaling that includes the indication of the codepoint that indicates the quantity of SD bases for each TRP and that indicates a selected SD basis for each TRP.

10. The method of claim 9, wherein a bit size for a field of the second CSI part that comprises the indication of the codepoint is based at least in part on the quantity of TRPs in the set of TRPs, or
wherein the bit size for the field of the second CSI part that indicates a selected SD basis for each TRP is based at least in part on half of a total quantity of ports per TRP and per polarization.

11. (canceled)

12. The method of claim 1, further comprising:
determining whether the quantity of SD bases selected by the UE is greater than a total quantity of ports per TRP and per polarization, wherein the CSI signaling is transmitted based at least in part on determining that the quantity of SD bases is not greater than the total quantity.

13. The method of claim 1, wherein a sum of the quantities of SD bases selected by the UE is less than the total quantity of SD bases for the set of TRPs, based at least in part on a quantity of ports for the set of TRPs is less than the total quantity of SD bases for the set of TRPs.

14. The method of claim 13, further comprising:
determining a maximum number of non-zero coefficients based at least in part on the total quantity of SD bases for the set of TRPs; or
determining a maximum number of non-zero coefficients based at least in part on the sum of the quantities of SD bases selected by the UE.

15. (canceled)

16. A method for wireless communications at a network entity, comprising:
transmitting, to a user equipment (UE) configuration information indicating resources for a set of transmission reception points (TRPs);
receiving, from the UE, channel state information (CSI) signaling that includes a codepoint associated with a quantity of spatial domain (SD) bases for each TRP in the set of TRPs; and
determining the quantity of SD bases for each TRP in the set of TRPs based at least in part on a quantity of TRPs in the set of TRPs, a total quantity of spatial domain (SD) bases for the set of TRPs, and the codepoint.

17. The method of claim 16, wherein receiving the CSI signaling comprises:
receiving a first CSI part of the CSI signaling that includes the indication of the codepoint that indicates the quantity of SD bases for each TRP; and
receiving, based at least in part on the first CSI part, a second CSI part of the CSI signaling that indicates a selected SD basis for each TRP.

18. The method of claim 16, wherein receiving the CSI signaling comprises:
receiving a first CSI part of the CSI signaling; and
receiving, based at least in part on the first CSI part, a second CSI part of the CSI signaling that includes the indication of the codepoint that indicates the quantity of SD bases for each TRP and that indicates a selected SD basis for each TRP.

19. The method of claim 18, wherein a bit size for a field of the second CSI part that comprises the indication of the codepoint is based at least in part on the quantity of TRPs in the set of TRPs, or
wherein the bit size for the field of the second CSI part that that indicates a selected SD basis for each TRP is based at least in part on half of a total quantity of ports per TRP and per polarization.

20.-25. (canceled)

26. A user equipment (UE), comprising a processing system that includes one or more processors coupled to a transceiver and one or more memories coupled with the one or more processors, the processing system configured to:
receive configuration information indicating resources for a set of transmission reception points (TRPs);
select a codepoint from a set of codepoints based at least in part on a quantity of TRPs in the set of TRPs and a total quantity of spatial domain (SD) bases for the set of TRPs, the codepoint indicating a quantity of SD bases selected by the UE for each TRP of the set of TRPs; and
transmit channel state information (CSI) signaling that includes an indication of the codepoint that indicates the quantity of SD bases selected by the UE for each TRP.

27. The UE of claim 26, wherein the processing system configured to transmit the CSI signaling comprises the processing system configured to:
transmit a first CSI part of the CSI signaling that includes the indication of the codepoint that indicates the quantity of SD bases for each TRP and that further includes an indication of a quantity of frequency domain (FD) bases for each TRP; and
transmit, based at least in part on the first CSI part, a second CSI part of the CSI signaling that indicates a selected SD basis for each TRP.

28. The UE of claim 27, the processing system further configured to:
receive an indication of a total quantity of frequency domain (FD) bases for the set of TRPs; and
determine, for each TRP of the set of TRPs, a quantity of FD bases for the TRP based at least in part on
the total quantity of FD bases,
the quantity of SD bases selected by the UE for the TRP, and further based on one of:
a maximum quantity of SD bases from the quantity of SD bases selected by the UE for the set of TRPs, or
the total quantity of SD bases for the set of TRPs.

29. The UE of claim 27, the processing system further configured to:
determine a quantity of bits based at least in part on a maximum number of TRPs in the set of TRPs for the indication of the codepoint to be transmitted in the first CSI part of the CSI signaling; and
select a subset of the bits for the indication of the codepoint based at least in part on the quantity of bits being less than a bit size of a field of the CSI signaling.

30. The UE of claim 26, wherein the processing system configured to transmit the CSI signaling comprises:
transmit a first CSI part of the CSI signaling; and
transmit, based at least in part on the first CSI part, a second CSI part of the CSI signaling that includes the indication of the codepoint that indicates the quantity of SD bases for each TRP and that indicates a selected SD basis for each TRP.

31. The UE of claim 26, the processing system further configured to:
determine whether the quantity of SD bases selected by the UE is greater than a total quantity of ports per TRP and per polarization, wherein the processing system configured to transmit the CSI signaling comprises the processing system configured to transmit the CSI signaling based at least in part on a determination that the quantity of SD bases is not greater than the total quantity.
